(19) United States
(12) Patent Application Publication
(10) Pub. No.: US 2024/0418454 A1
(43) Pub. Date: Dec. 19, 2024

(54) ENERGY STORAGE ENERGY SYSTEM

(71) Applicants: Quanling WANG, Qinhuangdao (CN); Miaohong WANG, Qinhuangdao (CN)

(72) Inventors: Quanling WANG, Qinhuangdao (CN); Miaohong WANG, Qinhuangdao (CN)

(21) Appl. No.: 18/788,094

(22) Filed: Jul. 29, 2024

Related U.S. Application Data
(63) Continuation of application No. PCT/CN2022/106500, filed on Jul. 19, 2022.

(30) Foreign Application Priority Data
Jan. 29, 2022 (CN) 202210112816.8

(51) Int. Cl. F28D 20/02; F28D 20/00

(52) U.S. Cl. CPC F28D 20/028; F28D 20/0034; F28D 2020/0026; F28D 2020/0047; F28D 2020/0078; F28D 2020/0082

(57) ABSTRACT

The present disclosure provides an energy storage energy system, which converts energy into cold power and/or heat power by utilizing an energy storage mode and stores the cold power and/or heat quantity. The stored cold power is used for a technology and a cold source of an existing freezing or air conditioner refrigeration industry; the stored heat power is used for a technology and heat source of an existing heating or heat supply industry. The energy storage energy system of the present disclosure adopts a large amount of wind power and photovoltaic power generation electric energy. The heat storage is applied to a current heating or heat supply market for sales which is mainly coal-fired. Cold storage subverts the existing refrigerant compression cycle technology, replaces refrigeration compressor freezing and air conditioning refrigeration systems; heat storage subverts boiler heat supply technology, replaces fossil fuel boiler heating and heat supply systems.

### CROSS REFERENCE TO RELATED APPLICATIONS

This application is a continuation application of international application number PCT/CN2022/106500, filed Jul. 19, 2022, which claims priority to Chinese patent application 202210112816.8, filed on Jan. 29, 2022. The contents of these applications are incorporated herein by reference in their entirety.

### TECHNICAL FIELD

The present disclosure relates to the technical field of energy conservation and emission reduction, especially to an energy storage energy system.

### BACKGROUND

Under the global dual-carbon target, all walks of life in the world take carbon neutral and carbon peak as the development direction, especially China's heating direction has been adjusted to the development route of coal to electricity.

The global refrigeration and refrigeration air conditioning industry use refrigerants to achieve refrigeration through the reverse Carnot cycle of refrigeration compressor. Refrigerant is recognized as one of the main culprits of the greenhouse effect in the world, and the Montreal International Convention has a strict limit on its use. After the signing of the convention, the world is developing low-fluorine green refrigeration systems, as well as refrigerant-free refrigeration and air conditioning systems.

Coal-fired power generation has a more serious greenhouse effect, with the global vigorous development of nuclear power, wind power and photovoltaic power generation to replace coal-fired power generation. China's wind power and photovoltaic power have become a world leader. However, the global abandonment of wind power and photovoltaic power generation has become a reality, and the rejection of urban power grids to accept wind power and photovoltaic power generation, has led to a huge wind power and photovoltaic power field development constraints bottleneck. The world should develop a way to overcome the losses of wind power and photovoltaic power generation, and at the same time find new ways to accept wind power and photovoltaic power generation market. In addition, one of the biggest defects and drawbacks affecting wind power and photovoltaic power generation is that wind power is restricted by wind, no wind, strong and weak wind, and its power generation is completely dependent on natural wind conditions; photovoltaic power generation is subject to the interference of nighttime, overcast, rain and snow weather. Therefore, the extremely unstable wind power and photovoltaic power generation must rely on the electricity storage and charging mode to achieve stable power supply. However, the use of battery charging and storage of electric energy increases the huge cost of battery, while the pollution of the battery production process is extremely serious, if the comprehensive evaluation, mass production of batteries, as well as battery scrap processing, will cause huge pollution to society, and the development of wind power and photovoltaic power generation environmental benefits compared,, the wind power and photovoltaic power generation are not much significance too society and environmental protection. If wind power and photovoltaic power generation do not adopt the development of electric storage, eliminate the production of a large number of batteries and eliminate the pollution brought to the society, then the development of energy storage to replace the road of development of power storage mode, its wind power and photovoltaic power generation are no longer completely dependent on the development path of battery storage, its environmental protection and social significance is great.

### SUMMARY

The first purpose of the present disclosure is to provide an energy storage energy system which is configured to solve the problems existing in the prior arts.

The present disclosure provides an energy storage energy system, in which the energy storage energy system converts energy into a cold power and/or a heat power by utilizing an energy storage mode and stores the cold power and/or heat quantity; and the cold power and/or the heat power is stored; the cold power is used as cold source of a freezing industry or an air conditioning refrigeration, and the heat power is used as heat source of a heating industry.

In another embodiment, the energy storage energy system includes energy sources, a cold storage, and/or a heat storage.

In another embodiment, the energy sources includes an electric energy, and the electric energy is generated by a wind power, a photovoltaic power generation, and a hydropower power generation, and a nuclear power, and a fossil fuel power generation, and a hydrogen energy generation, and an ammonia energy power generation and a public grid.
a heat energy, the heat energy is generated by a solar energy, a geothermal energy, and a renewable energy, and an industrial waste heat; and heat energy is also generated by a fossil fuel, a hydrogen combustion, and an ammonia combustion, and a biomass combustion.

In another embodiment, the cold storage includes a phase change cold storage, a sensible heat storage cold, or an absorption type cold storage. the heat storage includes a phase change heat storage or a sensible heat storage heat.

In another embodiment, the phase change cold storage includes a liquid air storage device, or a liquid nitrogen storage device, or a liquid carbon dioxide storage device, or a dry ice storage device, or an ice storage device.
the sensible heat storage cold includes an oil cold storage device, or an organic/inorganic solution cold storage device, or an antifreezing fluid storage or a water cold storage device. or
the absorption type cold storage includes a lithium bromide-water absorption/cold storage device, or an ammonia-water absorption/cold storage device.

In another embodiment, the phase change heat storage includes a molten salt heat storage device, or a chemical material phase change heat storage device. or
the sensible heat storage heat includes an oil heat storage device, or a chemical solution heat storage device, or a water heat storage device.

In another embodiment, the liquid air storage device includes an air compressor, a gas storage tank, and a heat exchanging device, and an expansion machine, and a liquid air storage tank; the heat exchanging device includes a heat exchanging device, a low temperature heat exchanging side, and a high temperature heat exchanging side, and a super low temperature heat exchanging side; an input end of the air compressor communicates with air; an output end of the air compressor is connected to an input end of the gas storage tank; the gas storage tank is output from a low temperature output end and a high temperature output end; wherein the low temperature output end is connected to an end of the low temperature heat exchanging side; and another end of the low temperature heat exchanging side is connected to an input interface of the liquid air storage tank, and is connected to the liquid air storage tank, and communicated with the liquid air; a high temperature output end is connected to an end of the high temperature heat exchanging side, another end of the high temperature heat exchanging side is connected to an input end of the expansion machine; an output end of the expansion machine is connected to an end of the super low temperature heat exchanging side, another end of the super low temperature heat exchanging side is connected to the input end of the air compressor.

In another embodiment, the liquid air storage device includes a liquid air storage tank, a liquid air inner storage tank and liquid air; a vacuum insulation layer is formed between the liquid air storage tank and the liquid air inner storage tank, and the liquid air is stored in the liquid air inner storage tank. or
the liquid air storage device also includes a motorized cold storage tank truck, the liquid air storage tank and a pressurizer; the liquid air storage tank is provided on the motorized cold storage tank truck.

In another embodiment, the energy storage energy system includes the liquid air storage tank, liquid air, and a coil liquid air throttle value, and/or a air cooler liquid air throttle value, and/or an air cooler, and/or a freezing coil; an end of the air cooler and/or the freezing coil is connected to the liquid air storage tank by the air cooler liquid air throttle value and/or the coil liquid air throttle value and communicated with the liquid air; another end of the air cooler and/or the freezing coil is connected to the air discharge outlet and communicated with the air.

In another embodiment, the energy storage energy system includes the liquid air storage tank, the liquid air, and a liquid air freezing cold storage device, and a freezing coil heat exchanging device, and a freezing medium, and a freezing coil throttle value, and a freezing medium circulating pump, and an air cooler and/or a freezing coil; the liquid air freezing cold storage device is equipped with a freezing medium, the freezing coil heat exchanging device is immersed in the freezing medium; an end of the freezing coil heat exchanging device is connected with the liquid air storage tank through the freezing coil throttle value and communicated with the liquid air; and another end of the freezing coil heat exchanging device is connected with the air discharge outlet and communicated with air; an end of the freezing medium circulating pump is connected to the liquid air freezing cold storage device and communicated with the freezing medium; another end of the freezing medium circulating pump is connected to the liquid air freezing cold storage device through the air cooler and/or the freezing coil and communicated with the freezing medium.

In another embodiment, the energy storage energy system includes the liquid air storage tank, the liquid air, a low temperature liquid air cold storage device, a low temperature freezing coil heat exchanging device, a low temperature freezing medium, a low temperature coil throttle value, a high temperature coil throttle value, a high temperature liquid air cold storage device, a high temperature freezing coil heat exchanging device, a gas-liquid mixer and a high temperature freezing medium; the low temperature freezing medium is provided in the low temperature liquid air cold storage device; the low temperature freezing coil heat exchanging device is immersed in the low temperature freezing medium, an end of the low temperature freezing coil heat exchanging device is connected to the liquid air storage tank through the low temperature coil throttle value and communicated with the liquid air; and another end of the low temperature freezing coil heat exchanging device is connected with an end of a high temperature freezing coil heat exchanging device of the high temperature liquid air cold storage device through the high temperature coil throttle value; the low temperature freezing medium is provided in the low temperature liquid air cold storage device; the low temperature freezing coil heat exchanging device is immersed in the low temperature freezing medium, an end of the low temperature freezing coil heat exchanging device is connected to the liquid air storage tank through the low temperature coil throttle value and communicated with the liquid air; and another end of the low temperature freezing coil heat exchanging device is connected with an end of a high temperature freezing coil heat exchanging device of the high temperature liquid air cold storage device through the high temperature coil throttle value; the high temperature liquid air cold storage device is equipped with a high temperature freezing medium; the high temperature freezing coil heat exchanging device is immersed in the high temperature freezing medium; an end of the high temperature freezing coil heat exchanging device is connected to the low temperature freezing coil heat exchanging device through the high temperature coil throttle value; and another end of the high temperature freezing coil heat exchanging device is connected to the gas-liquid mixer, and communicated with the high temperature freezing medium; wherein an end of the freezing medium circulating pump is connected to the high temperature liquid air cold storage device, and communicated with the high temperature freezing medium; and another end of the freezing medium circulating pump is connected to the high temperature liquid air cold storage device through the air cooler and/or the freezing coil, and communicated with the high temperature freezing medium.

In another embodiment, the energy storage energy system includes the liquid air storage tank, the liquid air, and a super low temperature liquid air cold storage device, and a super low temperature freezing coil heat exchanging device, and a super low temperature freezing medium, and a super low temperature throttle value, and a low temperature liquid air cold storage device, and a low temperature freezing coil heat exchanging device, and a low temperature freezing medium, and a low temperature throttle value, and a high temperature liquid air cold storage device, and a high temperature freezing coil heat exchanging device, and a high temperature freezing medium, and a high temperature throttle value, and the gas-liquid mixer; the super low temperature liquid air cold storage device is equipped with the super low temperature freezing medium, the super low temperature freezing coil heat exchanging device is immersed in the super low temperature freezing medium with an end connected to the liquid air storage tank through the super low temperature throttle value and communicated with the liquid air; an end of the freezing medium circulating pump is connected to the super low temperature liquid air cold storage device and communicated with the super low temperature freezing medium, and another end is connected to the liquid air ultra-cold storage device through the air cooler and/or freezing coil, and communicated with the super low temperature freezing medium; the low temperature liquid air cold storage device is equipped with the low temperature freezing medium, the low temperature freezing coil heat exchanging device is immersed in the low temperature freezing medium; an end of the low temperature freezing coil heat exchanging device is connected to the super low temperature freezing coil heat exchanging device through the low temperature throttle value, another end is connected to the high temperature freezing coil heat exchanging device through the high temperature throttle value; an end of the freezing medium circulating pump is connected to the liquid air cold storage device and communicated with the cryogenic freezing medium, and another end is connected to the liquid air cold storage device through a air cooler and/or freezing coil, and communicated with the cryogenic freezing medium; the high temperature liquid air cold storage device is provided with the high temperature freezing medium; the high temperature freezing coil heat exchanging device is immersed in the high temperature freezing medium; an end of the high temperature freezing coil heat exchanging device is connected to the low temperature freezing coil heat exchanging device through a high temperature throttle value; and another end of the high temperature freezing coil heat exchanging device is connected to the gas-liquid mixer; an end of the freezing medium circulating pump is connected to the high temperature liquid air cold storage device, and communicated with the high temperature freezing medium; and another end is connected to the high temperature liquid air cold storage device through the air cooler and/or the freezing coil, and communicated with the high temperature freezing medium.

In another embodiment, the energy storage energy system is liquid air freezer of a refrigerator, includes the liquid air storage tank, the liquid air, and a refrigerator freezer throttle value, and a liquid air freezer, and a refrigeration box, and a freezing coil, and a fresh-keeping box, and a high temperature coil and a freezer air outlet; the refrigeration box is provided with the freezing coil or the air cooler; an end of the freezing coil is connected with the liquid air storage tank through a throttle value, and communicated with the liquid air; the fresh-keeping box is provided with the high temperature coil or the air cooler; and an end of the high temperature coil is connected with the freezing coil; and another end is connected with the freezer air outlet and communicated with the air.

In another embodiment, the energy storage energy system includes the liquid air storage tank, the liquid air, and a ultra-low temperature liquid air freezing device, and a ultra-low temperature freezing throttle value and/or a ultra-low temperature coil throttle value, and a liquid air spray nozzle and/or a ultra-low temperature freezing coil, and a super low temperature liquid air freezing device, and a super low temperature freezing throttle value, and a low temperature liquid air freezing device, and an air cooler, and a low temperature liquid air releasing device; wherein the ultra-low temperature liquid air freezing device is equipped with a liquid air spray nozzle and/or a ultra-low temperature freezing coil; an end of the liquid air spray nozzle and/or the ultra-low temperature freezing coil is connected to the liquid air storage tank through the ultra-low temperature freezing throttle value and/or a ultra-low temperature coil throttle value, and communicated with the liquid air; and another end of the liquid air spray nozzle and/or the ultra-low temperature freezing coil is communicated with the ultra-low temperature liquid air freezing device; and/or another end of the ultra-low temperature freezing coil is connected to the super low temperature throttle value; wherein the super low temperature liquid air freezing device is provided with the air cooler; an end of the air cooler is connected to the super low temperature freezing throttle value; and another end of the air cooler is connected to the low temperature liquid air releasing device which is inside the low temperature liquid air freezing device; and the liquid air releasing device is communicated with the low temperature liquid air freezing device; wherein the low temperature liquid air freezing device includes the low temperature liquid air releasing device which is provided in the low temperature liquid air freezing device, and communicated with the low temperature liquid air freezing device; the low temperature liquid air releasing device is located inside the low temperature liquid air freezing device, an end of the low temperature liquid air releasing device is connected with the air cooler and another end is communicated with the low temperature liquid air freezing device.

In another embodiment, the energy storage energy system includes liquid air storage tank, the liquid air, the liquid air conditioning cold storage device, an air conditioning coil heat exchanging device, chilled water, an air conditioning throttle value, an air conditioning circulating pump and a fan coil air conditioner; wherein, the air conditioning coil heat exchanging device is immersed in chilled water, an end of the air conditioning coil heat exchanging device is connected with an end of the air conditioning throttle value, and another end of the air conditioning throttle value is connected with the liquid air storage tank and communicated with the liquid air, and another end of the air conditioning coil heat exchanging device is connected with the gas-liquid mixer and communicated with the chilled water; wherein, an end of the air conditioning circulating pump is connected to the liquid air air conditioning device and communicated with the chilled water; another end of the air conditioning circulating pump is connected to an end of the fan coil air conditioner, and another end of the fan coil air conditioner is connected to the liquid air conditioning device and communicated with the chilled water.

In another embodiment, the energy storage system includes liquid air storage tank, the liquid air, and a low temperature air conditioning cold storage device, and a low temperature air conditioning coil heat exchanging device, and the low temperature air conditioning coil heat exchanging device, and the low temperature chilled water, and the low temperature air conditioning throttle value, and an air conditioning throttle value, and an air conditioning cold storage device, and an air conditioning coil heat exchanging device, and a gas-liquid mixer, and the chilled water, and the air conditioning circulating pump, and the fan coil air conditioner; wherein the low temperature air conditioning coil heat exchanging device is immersed in the low temperature chilled water, the air conditioning coil heat exchanging device is immersed in the chilled water; and an end of the low temperature air conditioning coil heat exchanging device is connected to an end of the low temperature air conditioning throttle value, another end of the low temperature air conditioning throttle value is connected to the liquid air storage tank and communicated with the liquid air; another end of the low temperature air conditioning coil heat exchanging device is connected to an end of the air conditioning coil heat exchanging device through the air conditioning throttle value; another end of the air conditioning coil heat exchanging device is connected to the gas-liquid mixer, and communicated with the chilled water; wherein an end of the air conditioning circulating pump is connected to the low temperature air conditioning cold storage device and communicated with the low temperature chilled water; another end of the air conditioning circulating pump is connected to an end of the fan coil air conditioner; and another end of the fan coil air conditioner is connected to the low temperature air conditioning cold storage device and communicated with the low temperature chilled water; wherein an end of the air conditioning circulating pump is connected to the air conditioning cold storage device and communicated with the chilled water; an end of the air conditioning circulating pump is connected to an end of the fan coil air conditioner; and another end of the fan coil air conditioner is connected to the air conditioning cold storage device and communicated with the chilled water.

In another embodiment, the energy storage energy system includes the liquid air storage tank, the liquid air, and a liquid air split air conditioner; wherein the liquid air split air conditioner includes a coil surface air cooler and a fan; wherein an end of the coil surface air cooler is connected with the liquid air storage tank through the air conditioning throttle value and communicated with the liquid air; and another end of the coil surface air cooler is connected with the air releasing port and communicated with the air.
or
wherein the liquid air split air conditioner includes the coil surface air cooler, the fan, a split air conditioning thermal conductive oil storage tank, an electric heating device, thermal conductive oil, an air heater, a split air conditioning heating pump; wherein the air heater is located between the coil surface air cooler and the fan; an end of the air heater is connected to the split air conditioning thermal conductive oil storage tank through the split air conditioning heating pump and communicated with the thermal conductive oil; and another end of the air heater is connected with the split air conditioning thermal conductive oil storage tank and communicated with the thermal conductive oil.

In another embodiment, the molten salt heat storage device includes a molten salt heat storage tank, a molten salt, and the electric heating device, and a molten salt output interface, and a molten salt input interface; wherein the molten salt is located in the molten salt heat storage tank; the electric heating device is immersed in the molten salt; and the molten salt output interface is connected to the molten salt heat storage tank and communicated with the molten salt; and the molten salt input interface is connected to the molten salt heat storage tank and communicated with the molten salt. or
wherein the molten salt heat storage device includes a molten salt heat storage tank, the molten salt, and the electric heating device, and a molten salt coil heat exchanging device; wherein the molten salt is located in the molten salt heat storage tank; the electric heating device is immersed in the molten salt; and the molten salt coil heat exchanging device is immersed in the molten salt. or
wherein the molten salt heat storage device includes molten salt heat storage tank, the molten salt, and the electric heating device, and a molten salt heat exchanging device; wherein the molten salt is located in the molten salt heat storage tank; the electric heating device is immersed in the molten salt; and the molten salt heat exchanging device is immersed in the molten salt. or
wherein the molten salt heat storage device includes the molten salt heat storage tank, the molten salt, and an electric heating device, and the molten salt output interface, and the molten salt input interface; wherein the molten salt is provided in the molten salt heat storage tank, the electric heating device is immersed in the molten salt; and the molten salt heat storage tank is provided with the molten salt output interface and communicated with the molten salt; and the molten salt heat storage tank is provided with the molten salt input interface and communicated with the molten salt. or
wherein the molten salt heat storage device includes a single-phase power supply molten salt heat storage tank, the molten salt, and the electric heating device, and a molten salt input interface, and a molten salt output interface, and a molten salt heat exchanging device, and a molten salt heat exchanging device input interface, and a molten salt heat exchanging device output interface; wherein the molten salt is provided in the single- phase power supply molten salt heat storage tank; the electric heating device is immersed in the molten salt; and the single-phase power supply molten salt heat storage tank is provided with the molten salt input interface and communicated with the molten salt; and the single-phase power supply molten salt heat storage tank is provided with the molten salt output interface and communicated with the molten salt; and the molten salt heat exchanging device is immersed in the molten salt. or
wherein the molten salt heat storage device includes a molten salt heat storage tank, the molten salt, and the electric heating device, and the molten salt heat exchanging device; wherein the molten salt is located in the molten salt heat storage tank, the electric heating device is immersed in the molten salt; the molten salt heat tank is provided with the molten salt heat exchanging device and immersed in the molten salt.

In another embodiment, wherein the oil heat storage device includes an oil heat storage tank, a low temperature oil heat exchanging device and/or a high temperature oil heat exchanging device, the thermal conductive oil, and an electric heating device; wherein the thermal conductive oil is located in the oil heat storage tank; the electric heating device is immersed in the thermal conductive oil; and the low temperature oil heat exchanging device and/or the high temperature oil heat exchanging device are/is immersed in the thermal conductive oil. or
wherein the oil heat storage device includes an oil heat storage tank, an oil heat exchanging device, and the thermal conductive oil, and an electric heating device; wherein the oil heat storage tank is provided with the oil heat exchanging device and immersed in the thermal conductive oil; the electric heating device is immersed in the thermal conductive oil; or
wherein the oil heat storage device includes the oil heat storage tank, a low temperature oil heat exchanging device and/or a high temperature oil heat exchanging device, and the thermal conductive oil, and an electric heating device; wherein the oil heat storage tank is provided with the low temperature oil heat exchanging device and/or the high temperature oil heat exchanging device, and is immersed in the thermal conductive oil; and the electric heating device is immersed in the thermal conductive oil. or
wherein the oil heat storage device includes an oil heat storage and heat exchanging tank, a low temperature oil heat exchanging device and/or a high temperature oil heat exchanging device, and the thermal conductive oil; wherein the oil heat storage and heat exchanging tank is provided with the low temperature oil heat exchanging device and/or the high temperature oil heat exchanging device and immersed in the thermal conductive oil.

In another embodiment, the molten salt heat storage device includes a molten salt heat storage tank, a high temperature molten salt testing tank, and a high temperature tank heat exchanging device, and a high temperature tank, and a molten salt pump, and the molten salt, and the electric heating device; the high temperature tank heat exchanging device is located in the high temperature molten salt testing tank, an end of which is connected to the molten salt heat storage tank through the molten salt pump and communicated with the molten salt; another end of the high temperature tank heat exchanging device is connected to the molten salt heat storage tank and communicated with the molten salt. or
wherein the molten salt heat storage device includes a molten salt heat storage tank, the molten salt, and the electric heating device, and the molten salt heat exchanging device, and the molten salt heat exchanging pump, and thermal conductive oil heat storage exchanging tank, and a thermal conductive oil heat exchanging pump, and a high temperature molten salt testing tank, and a high temperature tank heat exchanging device, and the thermal conductive oil; wherein the molten salt heat storage tank is provided with the molten salt heat exchanging device; an end of the molten salt heat exchanging device is connected to the thermal conductive oil heat storage exchanging tank and communicated with the thermal conductive oil; another end of the molten salt heat exchanging device is connected to the thermal conductive oil heat storage exchanging tank and communicated with the thermal conductive oil; wherein an end of the thermal conductive oil heat exchanging pump is connected to an end of the thermal conductive oil heat storage exchanging tank and communicated with the thermal conductive oil; another end of the thermal conductive oil heat exchanging pump is connected to an end of the high temperature tank heat exchanging device; and another end of the high temperature tank heat exchanging device is connected to the thermal conductive oil heat storage exchanging tank and communicated with the thermal conductive oil;
the molten salt heat storage device includes a molten salt heat storage tank, the molten salt, and the electric heating device, and a thermal conductive oil heat exchanging tank, and the thermal conductive oil, and a molten salt heat exchanging pump, and a molten salt heat exchanging device, and a thermal conductive oil heat exchanging device, and a thermal conductive oil heat exchanging pump, and a hot water storage tank, and hot water and/or domestic hot water, and a hot water circulating pump, and a fan coil air conditioner and/or a floor heating and/or a bath shower; wherein the molten salt is provided in the molten salt heat storage tank, the molten salt heat storage tank is provided with the electric heating device and is immersed in the molten salt; the molten salt heat storage tank is provided with the molten salt heat exchanging device and is immersed in the molten salt; and an end of the molten salt heat exchanging device is connected to the thermal conductive oil heat exchanging tank through an end of the molten salt heat exchanging pump and communicated with the thermal conduction oil; and another end of the molten salt heat exchanging device is connected to the thermal conductive oil heat exchanging tank and communicated with the thermal conductive oil; wherein the thermal conductive oil exchanging tank is provided with the thermal conductive oil heat exchanging device and is immersed in the thermal conductive oil; an end of the thermal conductive oil heat exchanging device is connected with the hot water storage tank through the thermal conductive oil heat exchanging pump and communicated with the heating water or domestic hot water; and another end of the thermal conductive oil heat exchanging device is connected with the hot water storage tank and communicated with the hot water or domestic hot water; wherein an end of the hot water circulating pump is connected with the hot water storage tank and communicated with the hot water or domestic hot water; another end of the hot water circulating pump is connected with an end of the fan coil and/or the heating floor and/or the bath shower; another end of the fan coil air conditioner and/or the heating floor and/or the bath shower is connected with the hot water storage tank and communicated with the hot water or domestic hot water.

The molten salt heat storage device includes the high temperature molten salt heat storage tank, the molten salt, and a molten salt circulating pump, and the electric heating device, and a low temperature molten salt heat storage tank, and a low temperature molten salt heat exchanging device, and a water pump, and a water interface, and a steam storage tank, and steam, and steam output interface; wherein an end of the molten salt pump is connected with the high temperature molten salt heat storage and communicated with the molten salt; another end is connected to the low temperature molten salt heat storage tank and communicated with the molten salt; and the high temperature molten salt heat storage tank is connected to the low temperature molten salt heat storage tank and communicated with the molten salt; wherein an end of the low temperature molten salt heat exchanging device is connected to a water interface through a water pump; another end of the low temperature molten salt heat exchanging device is connected to a steam storage tank and communicated with the steam; and the steam is communicated with the steam output interface.

The energy storage energy system includes the liquid air storage tank, the liquid air, and the high temperature molten salt heat storage tank, and the molten salt, and the high temperature molten salt circulating pump, and the electric heating device, and the low temperature molten salt heat storage tank, and a low temperature molten salt heat exchanging pump, and a thermal conductive oil heat storage and heat exchanging tank, and a low temperature molten salt heat exchanging device, and a thermal conductive oil heat exchanging device, and a thermal conductive oil heat exchanging pump, and an air conditioning medium storage box, and the liquid air heat exchanging device, and the gas- liquid mixer, and the air conditioning cold and hot medium, and the air conditioning throttle value; wherein the air conditioning medium storage box is provided with the air conditioning cold and hot medium; and the liquid air heat exchanging device is immersed in the air conditioning cold and hot medium; an end of the liquid air heat exchanging device is connected to the liquid air storage tank and communicated with the liquid air; and another end of the liquid air heat exchanging device is connected with the gas-liquid mixer, and the gas-liquid mixer is immersed in the air conditioning cold and hot medium and communicated with the air conditioning cold and hot medium; wherein the high temperature molten salt storage tank is provided with the molten salt and the electric heating device; an end of the molten salt circulating pump is connected to the high temperature molten salt heat storage tank and communicated with the molten salt; and another end of the molten salt circulating pump is connected with the low temperature molten salt heat storage tank and communicated with the molten salt; the high temperature molten salt heat storage tank is connected to the low temperature molten salt heat storage tank and communicated with the molten salt; wherein the low temperature molten salt heat exchanging device is immersed in the low temperature molten salt heat storage tank; an end of the low temperature molten salt heat exchanging device is connected to the thermal conductive oil heat storage and heat exchanging tank through the low temperature molten salt heat exchanging pump and communicated with the thermal conductive oil; and another end of the low temperature molten salt heat exchanging device is connected to the thermal conductive oil heat storage and heat exchanging tank and communicated with the thermal conductive oil; wherein an end of the thermal conductive oil heat exchanging device is connected with the air conditioning medium storage box through the thermal conductive oil heat exchanging pump and communicated with the cold and hot medium; and another end of the thermal conductive oil heat exchanging device is connected with the air conditioning medium storage box and communicated with the cold and hot medium; wherein an end of the air conditioning circulating pump is connected to the air conditioning medium storage box and communicated with the cold and hot medium; another end of the air conditioning circulating pump is connected with an end of the fan coil air conditioner and/or the heating floor; and another end of the fan coil air conditioner and/or the heating floor is connected to the air conditioning medium storage box and communicated with the cold and hot medium.

The energy storage energy system includes the liquid air storage tank, the liquid air, and a molten salt heat storage tank, and the molten salt, and the electric heating device, and a thermal conductive oil heat storage and heat exchanging tank, and the thermal conductive oil, and a molten salt heat exchanging device, and a molten salt heat exchanging pump, and a thermal conductive oil exchanging pump, and an air conditioning cold and hot medium box, and a refrigerant heat exchanging device, and a liquid air throttle value, and a heat medium heat exchanging device, and the cold and hot medium, and the air conditioning circulating pump, and the fan coil air conditioner and/or the floor heating; wherein an end of the refrigerant heat exchanging device is connected to the liquid air storage tank through the liquid air throttle value and communicated with the liquid air; and another end of the refrigerant heat exchanging device is connected to the gas-liquid mixer and communicated with the cold and hot medium; wherein an end of the molten salt heat exchanging pump is connected to an end of the thermal conductive oil heat storage and heat exchanging tank and communicated with the thermal conductive oil; another end of the molten salt heat exchanging pump is connected to an end of the molten salt heat exchanging device; and another end of the molten salt heat exchanging device is connected to the thermal conductive oil heat storage and heat exchanging tank and communicated with the thermal conductive oil; wherein an end of the thermal conductive oil heat exchanging pump is connected to an end of the thermal conductive oil heat storage and heat exchanging tank and communicated with the thermal conductive oil; another end of the thermal conductive oil heat exchanging pump is connected to an end of the heat medium heat exchanging device; and another end of the heat medium heat exchanging device is connected to the thermal conductive oil heat storage and heat exchanging tank and communicated with the thermal conductive oil; wherein an end of the air conditioning circulating pump is connected to the air conditioning medium storage box and communicated with the cold and hot medium; another end of the air conditioning circulating pump is connected to an end of the fan coil air conditioner and/or the heating floor; and another end of the fan and coil air conditioner and/or the heating floor is connected to the air conditioning medium storage box and communicated with the cold and hot medium.

The energy storage energy system includes the liquid air storage tank, the liquid air, and the molten salt heat storage tank, and the molten salt, and the electric heating device, and the thermal conductive oil heat storage and heat exchanging tank, and the thermal conductive oil, and a molten salt heat exchanging device, and a molten salt heat exchanging pump, and a thermal conductive oil heat exchanging pump, and an air conditioning cold and hot medium tank, and a refrigerant heat exchanging device, the thermal conductive oil output heat exchanging device, and the air conditioning throttle value, and the cold and hot medium; wherein an end of the refrigerant heat exchanging device is connected to the liquid air storage tank through the air conditioning throttle value and communicated with the liquid air; and another end of the refrigerant heat exchanging device is connected to the gas-liquid mixer and communicated with the cold and hot medium; wherein an end of the molten salt heat exchanging device is connected to the thermal conductive oil heat storage and heat exchanging tank through the molten salt heat exchanging pump and communicated with the thermal conductive oil; another end of the molten salt heat exchanging device is connected with the thermal conductive oil heat storage and heat exchanging tank and communicated with the thermal conductive oil; wherein an end of the thermal conductive oil output heat exchanging device is connected with the air conditioning cold and hot medium tank through the thermal conductive oil heat exchanging pump and communicated with the cold and hot medium, and another end of the thermal conductive oil output heat exchanging device is connected with the air conditioning cold and hot medium tank and communicated with the cold and hot medium; wherein an end of the air conditioning circulating pump is connected to the air conditioning cold and hot medium tank and communicated with the cold and hot medium; another end of the air conditioning circulating pump is connected to an end of the fan coil air conditioner and/or the heating floor; and another end of the fan coil air conditioner and/or heating floor is connected to the air conditioning cold and hot medium tank and communicated with the cold and hot medium.

The energy storage energy system includes the liquid air storage tank, the liquid air, and the thermal conductive oil heat storage tank, and the thermal conductive oil heat exchanging pump, and the thermal conductive oil, and the electric heating device, and the thermal conductive oil heat exchanging device, and the thermal conductive oil heat exchanging pump, and the thermal conductive oil heat storage and heat exchanging tank, and the heat medium water heating coil, and the air conditioning cold and hot medium tank, and the air conditioning refrigerant coil, and the air conditioning throttle value, and the cold and hot medium, and the air conditioning circulating pump, and the fan coil air conditioner and/or the floor heating; wherein an end of the air conditioning refrigerant coil is connected to the liquid air storage tank through an air conditioning throttle value and communicated with the liquid air; and another end of the air conditioning refrigerant coil is connected to the gas-liquid mixer and communicated with the cold and hot medium; wherein the thermal conductive oil heat exchanging device is connected to the thermal conductive oil heat storage tank through the thermal conductive oil heat exchanging pump and communicated with the thermal conductive oil; and another end of the thermal conductive oil heat exchanging device is connected to the thermal conductive oil heat storage tank and communicated with the thermal conductive oil; wherein an end of the thermal conductive oil output heat exchanging pump is connected to an end of the thermal conductive oil heat storage and heat exchanging tank and communicated with the thermal conductive oil; another end of the thermal conductive oil output heat exchanging pump is connected to an end of the heat medium water heat exchanging device; and another end of the heat medium water heat exchanging device is connected to another end of the thermal conductive oil heat storage and heat exchanging tank and communicated with the thermal conductive oil; wherein an end of the air conditioning circulating pump is connected to the air conditioning cold and hot medium tank and communicated with the cold and hot medium; another end of the air conditioning circulating pump is connected to an end of the fan coil air conditioner and/or the heating floor; and another end of the fan and coil air conditioner and/or the heating floor is connected to the air conditioning cold and hot medium tank and communicated with the cold and hot medium.

The energy storage energy system includes the liquid air storage tank, the liquid air, and the thermal conductive oil heat storage tank, and the thermal conductive oil heat exchanging device, and a thermal conductive oil heat exchanging pump, and an air conditioning cold and hot medium box, and the cold and hot medium, and a refrigerant water heat exchanging device, and an air conditioning throttle value, and the electric heating device, and the thermal conductive oil; wherein an end of the refrigerant water heat exchanging device is connected to the liquid air storage tank through the air conditioning throttle value and communicated with the liquid air; and another end of the refrigerant water heat exchanging device is connected to the gas-liquid mixer and communicated with the cold and hot medium; wherein an end of the thermal conductive oil heat exchanging device is connected to the air conditioning cold and hot medium box through the thermal conductive oil heat exchanging pump and communicated with the cold and hot medium; and another end of the thermal conductive oil heat exchanging device is connected to the air conditioning cold and hot medium box and communicated with the cold and hot medium; wherein an end of the air conditioning circulating pump is connected to the air conditioning cold and hot medium box and communicated with the cold and hot medium; another end of the air conditioning circulating pump is connected to an end of the fan coil air conditioner and/or the heating floor; and another end of the fan coil air conditioner and/or heating floor is connected to the air conditioning cold and hot medium box and connected to the cold and hot medium.

The energy storage energy system includes a thermal conductive oil heat storage tank, a thermal conductive oil circulating pump, and a heater, and an air heating heat exchanging device, and a heater air inlet, and a heater air outlet, and a fan; wherein the thermal conductive oil heat storage tank is provided with an electric heating device, and the electric heating device is immersed in the thermal conduction oil; wherein the heater is provided with an air heating heat exchanging device; an end of the air heating heat exchanging device is connected with the thermal conductive oil heat storage tank through the thermal conductive oil circulating pump and communicated with the thermal conductive oil; and another end of the air heating heat exchanging device is connected with the thermal conductive oil heat storage tank and communicated with the thermal conductive oil.

The molten salt heat storage device includes a molten salt or thermal conductive oil heat storage outer tank, a molten salt or thermal conductive oil heat storage inner tank, and an outer/inner vacuum insulation gap, and the molten salt or the thermal conductive oil, and the electric heating device; wherein the outer/inner vacuum insulation gap is formed in the gap between the molten salt or thermal conductive oil heat storage outer tank and the molten salt or thermal conductive oil heat storage inner tank. or
wherein the molten salt heat storage device includes the molten salt or thermal conductive oil heat storage outer tank, a molten salt or thermal conductive oil heat storage inner tank, and the outer/inner vacuum insulation gap, and the high temperature insulation material, and the molten salt or the thermal conductive oil, and the electric heating device; wherein the outer/inner vacuum insulation gap is formed in the gap between the molten salt or thermal conductive oil heat storage outer tank and the molten salt or thermal conductive oil heat storage inner tank, and the high temperature insulation material is added. or
wherein the molten salt heat storage device includes the molten salt heat storage outer tank, a molten salt heat storage inner tank, and a high temperature insulation material of the outer/inner tank, and a burner, and a flame heat radiation sheath, a flame, and a chimney; wherein a gap between the molten salt heat storage outer tank and the molten salt heat storage inner tank is filled with the high temperature insulation material; the burner is provided on a lower of the molten salt heat storage outer tank; and the flame passes through the molten salt, and the flame burns in the flame heat radiation sheath; and the flame heat radiation sheath is provided between the flame and the molten salt.

The molten salt heat storage includes a solid heat storage device, a fire-resistant insulation brick, and a solid heat storage material; wherein the solid heat storage material is provided in the fire-resistant insulation brick; and the electric heating device is provided in the solid heat storage material and is in contact with the solid heat storage material.

The energy storage energy system in this disclosure is configured to adopt a large amount of wind power, photovoltaic power generation electric energy, supplemented by and absorb the valley power from the urban power grid, instead of battery storage, and store cold and heat with electric energy, and sends the cold and hot energy stored to a freezing and air conditioning industry market as commodities for direct sales. Compared with the prior art, the excess electricity is used to charge the battery, and the battery is discharged into the network during the peak of electricity consumption, which saves the loss in the process of energy conversion and improves the utilization rate of energy. Not only promote the dual-carbon target, but also can subvert the refrigerant compression cycle system, cold storage subverts the existing refrigerant compression cycle refrigeration technology, replaces refrigeration compressor freezing and air conditioning refrigeration systems; heat storage subverts boiler heat supply technology, replaces fossil fuel boiler heating and heat supply systems. And the heat storage is applied to a current heating or heat supply market for sales which is mainly coal-fired. This present disclosure of the energy storage refrigeration, the air conditioning, the heating and heating system are also configured to reduce the production and use of batteries, not only reduce the ownership of batteries for the society, but also can avoid the application process of electric storage and charging, and the frequent battery explosion and combustion accidents. Its environmental protection and social significance is immeasurable.

### Beneficial Effects of This Disclosure

1. The cold storage of the present disclosure will be used in a refrigeration house, as well as a cold source in the low temperature freezing industry or the air conditioning refrigeration industry, and has the following beneficial effects; replacing an existing refrigeration system of refrigerant refrigeration and compression circulation, so as to eliminate the damage of the refrigerant to the ozone layer and alleviate the greenhouse effect.
2. The heat storage of the present disclosure will be used in the industry of heating, domestic hot water, steam, and high temperature heat supply, and has the beneficial effects that the existing coal-fired, gas-fired boiler heating or heat supply technology system and the high-energy-consumption and low-energy-efficiency ratio air source heat pump winter heating and heat supply system used for existing coal modification are replaced, so that heating and heat supply do not rely on coal-fired and natural gas heating for heating, and carbon dioxide emission is reduced.
3. In the liquid air cooling system of the present disclosure, the air phase is changed to 193° C. and stored, and the liquid-air natural cold source is obtained to implement a natural ecological cycle refrigeration system for the freezing industry and the air conditioning industry; after the liquid air is released by the refrigeration operation, the air is re-regressed; it is an ideal, natural and environment-friendly refrigeration system, which completely conforms to the target of double-carbon development, so as to limit the early day of the Librier protocol, and eliminate the refrigerant in one of the greenhouse effects caused by damaging the ozone layer; the liquid-air cold storage refrigeration system replaces the refrigeration compressor industry of the refrigerant and replaces the refrigeration system of the refrigerant-type refrigeration compressor.
4. The number of the air-conditioning refrigeration compressors is huge, and the cost of the maintenance accessories is far higher than the price of purchasing the compressors, so that the users generally do not have complex maintenance skills of the compressor units, the constructed air-conditioning machine room does not carry out operation and maintenance management, most users do not need to carry out operation and maintenance by using outsourcing or patron, and the operation cost is quite large every year; the liquid-air cooling system of the present disclosure is very simple in technical system, as with tap water, maintenance management is easy, no special technical worker is needed, and the system can run safely through simple training; the technical promotion refers to saving huge operation and maintenance management costs for users each year, which is of great social significance.
5. In the liquid-air cooling system of the present disclosure, because a large amount of air phase becomes the low temperature liquid air, and then gasification and refrigeration are reduced to air, the temperature of the reduced air is much lower than that of the atmosphere, and the average temperature of the low atmosphere is much lower than the air temperature of the atmosphere, which can play a certain positive auxiliary role in relieving the global greenhouse effect, eliminate the ozone layer consumption caused by the refrigerant, and relieve the greenhouse effect caused by carbon dioxide.
6. In the liquid-air cooling system of the present disclosure, the cold storage peak regulation of the public power grid in summer, especially the power plant with no heat storage peak regulation in the southern part can be met, and the refrigeration industry of the cold storage for the central air conditioner refrigeration or freezing plant can be selected as a cold source for sale; a great significance to the flexible peak regulation of a power plant is a supplement to pumping or compressed-air energy storage of a public power grid.
7. In the molten salt heat storage system of the present disclosure, wind power, photovoltaic power generation, nuclear power, and coal-fired power generation are performed, and the valley electricity thereof changes the molten salt phase into a high temperature liquid state and stores the molten salt phase for heating, domestic hot water, steam, and high temperature heat supply places, as well as heating in winter and low energy efficiency of the air source heat pump.
8. Rural combustion straw is a large problem, especially India countries, resulting in large-area severe haze weather due to burning of straw every year; although straw has been subjected to environmental protection treatment in China, straw granular fuel is prepared; however, in residential area heating and combustion, although no dense smoke exists, unpleasant odor is still generated, and meanwhile, a lot of gas pollutants are released from the flue gas, so that the atmosphere is continuously polluted; in the molten salt heat storage system of the present disclosure, after the straw is treated, the straw can be concentrated in a special incineration field for combustion, and is stored through the molten salt for the high temperature heat storage, and is sent to the residential district for heating and heating by using the vehicle-mounted molten salt storage tank, which is a good way of sustainable development of rural straw.
9. The energy storage energy system of the present disclosure utilizes the perfect combination of molten salt heat storage and liquid-air cold storage, can store a large amount of electric energy for absorbing wind power and photovoltaic power generation, and can effectively alleviate the impact of wind power and photovoltaic power generation on the impact of the impact of wind power and photovoltaic power generation on the power grid, as well as the problems of wind curtailment and photovoltaic power generation; in particular, a perfect combination of molten salt heat storage and liquid-air cold storage is used in winter to absorb wind power, photovoltaic power generation, and valley electric energy of an urban public power grid in winter, and is used for northern heating and heat supply; in summer, wind power, photovoltaic power generation, and electric energy of an urban public power grid are stored and absorbed by liquid-air cold storage, and are used for south and north refrigeration air conditioners, and are ideal environmental protection and green ecological circulation systems; it is possible to accelerate the heating and heat supply of coal in China and achieve the target of carbon neutralization and carbon up-to-peak in the morning.

### BRIEF DESCRIPTION OF THE DRAWINGS

In order to more clearly explain the specific embodiments of the present disclosure or the technical scheme of the prior arts, the drawings required to be used in the specific embodiments or the prior arts description will be briefly introduced below, and obviously, the drawings described below are some embodiments of the present disclosure. for ordinary technicians in the field, other drawings can also be obtained without giving creative labor.

FIG. 1 is a principle diagram of according to an embodiment of the present disclosure;

FIG. 2 is a schematic diagram of the energy according to an embodiment of the present disclosure;

FIG. 3A is a schematic diagram of the cold storage according to an embodiment of the present disclosure;

FIG. 3B is a schematic diagram of the heat storage according to an embodiment of the present disclosure;

FIG. 4A is a schematic diagram of the phase change cold storage according to an embodiment of the present disclosure;

FIG. 4B is a schematic diagram of the sensible heat storage cold according to an embodiment of the present disclosure;

FIG. 4C is a schematic diagram of the ammonia-water absorption/cold storage according to an embodiment of the present disclosure;

FIG. 5A is a schematic diagram of the phase change heat storage according to an embodiment of the present disclosure;

FIG. 5B is a schematic diagram of the sensible heat storage heat according to an embodiment of the present disclosure;

FIG. 6 is a schematic diagram of the liquid air extraction and liquid air storage according to an embodiment of the present disclosure;

FIG. 7A is a schematic diagram of the liquid air storage according to an embodiment of the present disclosure;

FIG. 7B is a schematic diagram of the liquid air storage and transportation according to an embodiment of the present disclosure;

FIG. 8 is a schematic diagram of the liquid air freezing device according to an embodiment of the present disclosure;

FIG. 9 is a schematic diagram of the liquid air cold storage system according to an embodiment of the present disclosure;

FIG. 10 is a schematic diagram of the embodiment of the high temperature liquid air cold storage fresh storage according to an embodiment of the present disclosure;

FIG. 11 is a schematic diagram of the super low temperature liquid air cold storage freezing, the low temperature cold storage, and the high temperature fresh storage refrigeration system according to an embodiment of the present disclosure;

FIG. 12 is a schematic diagram of the liquid air refrigerator and freezer according to an embodiment of the present disclosure;

FIG. 13 is a schematic diagram of the ultra-low temperature, the super low temperature and the low temperature liquid air test box according to an embodiment of the present disclosure;

FIG. 14 is a schematic diagram of the liquid air air conditioning cold water refrigeration system according to an embodiment of the present disclosure;

FIG. 15 is a schematic diagram of the liquid air with the chilled water at 2° C. and 7° C. of a super central air conditioning refrigeration system according to an embodiment of the present disclosure;

FIGS. 16A and 16B are schematic diagrams of liquid air refrigeration and/or conductive oil heating split air conditioning according to an embodiment of the present disclosure;

FIG. 17A is a schematic diagram of the molten salt power electric heat storage with molten salt interface according to an embodiment of the present disclosure;

FIG. 17B is a schematic diagram of the molten salt power electric heat storage with molten salt interface and heat exchanging device according to an embodiment of the present disclosure;

FIG. 17C is a schematic diagram of the molten salt power electric heat storage with heat exchanging device according to an embodiment of the present disclosure;

FIG. 17D is a schematic diagram of the molten salt single-phase electric heat storage with molten salt interface according to an embodiment of the present disclosure;

FIG. 17E is a schematic diagram of the molten salt single-phase electric heat storage with molten salt interface and heat exchanging device according to an embodiment of the present disclosure;

FIG. 17F is a schematic diagram of the molten salt single-phase electric heat storage with heat exchanging device according to an embodiment of the present disclosure;

FIG. 18A is a schematic diagram of the thermal conductive oil power electric heat storage with heat exchanging device according to an embodiment of the present disclosure;

FIG. 18B is a schematic diagram of the thermal conductive oil single-phase electric heat storage with heat exchanging device according to an embodiment of the present disclosure;

FIG. 18C is a schematic diagram of the thermal conductive oil single-phase electric with heat exchanging heat storage tank according to an embodiment of the present disclosure;

FIG. 18D is a schematic diagram of the thermal conductive oil heat exchanging device according to an embodiment of the present disclosure;

FIGS. 19A and 19B are schematic diagram of the high temperature molten salt heat storage hardening furnace and test box according to an embodiment of the present disclosure;

FIG. 20 is a schematic diagram of the molten salt heat storage and heating and bath system according to an embodiment of the present disclosure;

FIG. 21 is a schematic diagram of the molten salt heat storage steam system according to an embodiment of the present disclosure;

FIG. 22 is a schematic diagram of the liquid air refrigeration and molten salt heating central air conditioning system according to an embodiment of the present disclosure;

FIG. 23 is a schematic diagram of liquid air refrigeration and molten salt heating central air conditioning system according to an embodiment of the present disclosure;

FIG. 24 is a schematic diagram of the liquid air refrigeration and molten salt heating domestic central air conditioning system according to an embodiment of the present disclosure;

FIG. 25 is a schematic diagram of the liquid air refrigeration and power electric thermal conductive oil heat storage air conditioning system according to an embodiment of the present disclosure;

FIG. 26 is a schematic diagram of the liquid air refrigeration and single-phase thermal conductive oil heat storage domestic central air conditioning system according to an embodiment of the present disclosure;

FIG. 27 is a schematic diagram of the thermal conductive oil energy storage heater according to an embodiment of the present disclosure;

FIG. 28A is a schematic diagram of the molten salt storage tank according to an embodiment of the present disclosure;

FIG. 28B is a schematic diagram of the molten salt storage tank according to an embodiment of the present disclosure

FIG. 28C is a schematic diagram of the molten salt storage tank according to an embodiment of the present disclosure;

FIG. 29 is a schematic diagram of the solid heat storage device according to an embodiment of the present disclosure.

### BRIEF DESCRIPTION OF THE DRAWINGS

1. Energy source, 2. Cold storage, 3. Heat storage, 4. Electric energy, 5. Heat energy, 6. Phase change cold storage, 7. Sensible heat storage cold, 8, Phase change heat storage, 9. Sensible heat storage heat, 10. liquid air storage device, 11. Liquid nitrogen storage device, 12. Liquid carbon dioxide storage device, 13. Dry ice storage device, 14. Ice storage device, 15. Oil cold storage device, 16, Organic inorganic solution cold storage device, 17, Antifreezing fluid storage, 18. Molten salt heat storage device, 19, chemical material phase change heat storage device, 20. Oil heat storage device, 21. Chemical solution heat storage device, 22. Water heat storage device, 23. Air compressor, 24. Air compressor input end, 25. Output end of the air compressor, 26. Gas storage tank, 27. Gas storage tank input end, 28. Low temperature output end of the gas storage tank, 29. Heat exchanging device, 30. heat exchanging device, 31. Low temperature heat exchanging side, 32. High temperature heat exchanging side, 33. Super low temperature heat exchanging side, 34. Low temperature heat exchanging side input end, 35. Low temperature heat exchanging side output end, 36. Liquid air storage tank liquid filling interface, 37. High temperature output end of the gas storage tank, 38. High temperature heat exchanging side input end, 39. High temperature heat exchanging side output end, 40. Expansion machine input end, 41. Expansion machine output end, 42. Super low temperature heat exchanging side input end, 43. Super low temperature heat exchanging side input end, 44. Liquid air storage tank liquid filling shut-off valve, 45. Liquid air storage tank, 46. Liquid air, 47. Liquid air inner storage tank, 48. Liquid air storage tank liquid supply shut-off valve, 49. Liquid air storage tank liquid supply interface, 50. Motorized cold storage tank truck, 51. Expansion machine, 52. Pressurizer, 53. The pressurizer interface, 54. Refrigerator freezer liquid air interface, 55. Liquid air freezing cold storage device, 56. Freezing coil heat exchanging device, 57. Air cooler liquid air throttle value, 58. Freezing medium, 59. Air discharge outlet, 60. Thermal insulation material, 61. Coil fluid air interface, 62. Freezing coil throttle value, 63. Freezing medium circulating pump, 64. Air cooler, 65. Freezing coil, 66. Low temperature liquid air cold storage device, 67. Low temperature freezing coil heat exchanging device, 68. Freezing liquid interface, 69. Low temperature freezing medium, 70. Low temperature coil throttle value, 71. The high temperature coil throttle value, 72. High temperature liquid air cold storage device, 73. High temperature freezing coil heat exchanging device, 74. Gas-liquid mixer, 75. High temperature freezing medium, 76. Super low temperature liquid air cold storage device, 77. Super low temperature freezing coil heat exchanging device, 78. Freezing liquid air interface, 79. Super low temperature freezing medium, 80. The low temperature throttle value, 81. Low temperature liquid air cold storage device, 82. The low temperature freezing coil heat exchanging device, 83. Freezing liquid air interface, 84. Low temperature freezing medium, 85. High temperature throttle value, 86. high temperature liquid air cold storage device, 87. High temperature freezing coil heat exchanging device, 88. Coil fluid air throttle value, 89. High temperature freezing medium, 90. super low temperature throttle value, 91. Freezer solenoid valve, 92. Refrigerator freezer throttle value, 93. Refrigerator freezer, 94. Refrigeration box, 95. Freezing coil, 96. Fresh-keeping box, 97. High temperature coil, 98 Freezer air outlet, 99. Ultra-low temperature liquid air freezing device, 100. Low temperature test box liquid air interface, 101. Ultra-low temperature freezing throttle value, 102. Liquid air spraying nozzle, 103. Ultra-low temperature freezing coil, 104. Super low temperature freezing throttle value, 105. Super low temperature liquid air freezing device, 106. Low temperature liquid air freezing device, 107. Air cooler, 108. Low temperature liquid air releasing device, 109. Ultra-low temperature coil throttle value, 110. Test box liquid air interface, 111. Liquid air air conditioning cold storage device, 112. Air conditioning coil heat exchanging device, 113. Gas-liquid mixer, 114. Chilled water, 115. Air conditioning coil throttle valve, 116. Air conditioning liquid air interface, 117. Air conditioning circulating pump, 118. Fan coil air conditioner, 119. Low temperature air conditioning cold storage device, 120. Low temperature air conditioning coil heat exchanging device, 121. Air check valve, 122. Low temperature chilled water, 123. Low temperature air conditioning throttle value, 124. Low temperature air conditioning liquid air interface, 125. Air conditioning throttle value, 126. Air conditioning cold storage device, 127. Air conditioning coil heat exchanging device, 128. Heating floor heating, 129. Thermal conductive oil, 130. Liquid air split air conditioner, 131. Coil surface air cooler, 133. Fan, 134. Air inlet, 135. Air outlet, 136. Split air conditioning air releasing port, 137. Split air conditioning throttle value, 138. Split air conditioning solenoid valve, 139. Molten salt heat storage tank, 140. Molten salt inner heat storage tank, 141. Molten salt, 142. Molten salt output interface, 143. Molten salt input interface, 144. Power source, 145. Electric heating device, 146. Single-phase power supply, 147. Molten salt heat storage tank, 148. Molten salt inner heat storage tank, 149. Molten salt input interface, 150. Molten salt output interface, 151. Molten salt coil heat exchanging device, 152. Molten salt coil input interface, 153. Molten salt coil output interface, 154. Molten salt heat storage tank, 155. Molten salt inner heat storage tank, 156. Molten salt heat exchanging device input interface, 157. Molten salt heat exchanging device output interface, 158. Molten salt heat storage tank, 159. Molten salt inner heat storage tank, 160. Molten salt heat exchanging device, 161. Molten salt heat exchanging device input interface, 162. Molten salt heat exchanging device output interface, 163. Oil heat storage tank, 164. Oil inner heat storage tank, 165. Electric heating device, 166. Low temperature oil heat exchanging device, 167. Low temperature oil heat exchanging device input interface, 168. Low temperature oil heat exchanging device output interface, 169. The high temperature oil heat exchanging device, 170. High temperature oil heat exchanging device input interface, 171. High temperature oil heat exchanging device output interface, 172. Oil heat storage and heat exchanging tank, 173. Oil heat storage and heat exchanging inner tank, 174. Low temperature oil heat exchanging device, 175. Low temperature oil heat exchanging device input interface, 176. Low temperature oil heat exchanging device output interface, 177. High temperature oil heat exchanging device, 178. The high temperature oil heat exchanging device input interface, 179. The high temperature oil heat exchanging device output interface, 180. Oil heat storage tank, 181. Oil inner heat storage tank, 182. Oil heat exchanging device, 183. Oil heat exchanging device input interface, 184. Oil heat exchanging device output interface, 185. Oil heat storage tank, 186. Oil inner heat storage tank, 187. Low temperature oil heat exchanging device, 188. Low temperature oil heat exchanging device input interface, 189. low temperature oil heat exchanging device output interface, 190. high temperature oil heat exchanging device, 191. High temperature oil heat exchanging device input interface, 192. high temperature oil heat exchanging device output interface, 193. Molten salt heat storage tank, 194. molten salt heat storage inner tank, 195. Molten salt heat storage tank, 196. molten salt heat storage inner tank, 197. Molten salt heat exchanging pump, 198. Thermal conductive oil heat exchanging tank, 199. Thermal conductive oil heat exchanging inner tank, 200. Molten salt heat exchanging device, 201. Thermal conductive oil heat exchanging device, 202. Thermal conductive oil heat exchanging pump, 203. Hot water storage tank, 204. Hot water, 205. Tap water interface, 206. Air conditioning circulating pump, 207. Fan coil air conditioner, 208. Floor heating, 209. Bath shower, 210. High temperature molten salt heat storage tank, 211. high temperature molten salt heat storage inner tank, 212. Molten salt circulating pump, 213. Low temperature molten salt heat storage tank, 214. Low temperature molten salt heat storage and heat exchanging inner tank, 215. Check valve, 216. Steam-based generator, 217, Check valve, 218. Water pump, 219. Water interface, 220. Steam storage tank, 221. Steam, 222. Valve, 223. Steam output interface, 224. Low temperature molten salt heat exchanging pump, 225. Thermal conductive oil heat storage and heat exchanging tank, 226. Thermal conductive oil heat storage and heat exchanging inner tank, 227. Low temperature molten salt heat exchanging device, 228. Thermal conductive oil heat exchanging device, 229. Thermal conductive oil heat exchanging pump, 230. Air conditioning medium storage box, 231. Liquid air heat exchanging device, 232. Gas and water mixer, 233. Air conditioning cold and hot medium, 234. Air conditioning throttle value, 235. Molten salt heat storage tank, 236. Molten salt heat storage inner tank, 237. Thermal conductive oil heat storage and heat exchanging tank, 238. Thermal conductive oil heat storage and heat exchanging inner tank, 239. Molten salt heat exchanging device, 240. Molten salt heat exchanging pump, 241. Thermal conductive oil heat exchanging pump, 242. Air conditioning cold and hot medium box, 243. Refrigerant heat exchanging device, 244. Air conditioning throttle value, 245. Air conditioning fluid interface, 246. Heat medium heat exchanging device, 247. Molten salt heat storage tank, 248. Molten salt heat storage inner tank, 249. Thermal conductive oil heat storage and heat exchanging tank, 250. Thermal conductive oil heat storage and heat exchanging inner tank, 251. Molten salt heat exchanging device, 252. Molten salt heat exchanging pump, 253. Thermal conductive oil heat exchanging pump, 254. Thermal conductive oil output heat exchanging device, 255. Thermal conductive oil heat storage tank, 256. Thermal conductive oil heat storage inner tank, 257. Thermal conductive oil heat exchanging pump, 258. Thermal conductive oil heat storage and heat exchanging tank, 259. Thermal conductive oil heat storage and heat exchanging inner tank, 260. Heat medium water heating coil, 261. Air conditioning cold and hot medium tank, 262. Air conditioning refrigerant heat exchanging device, 263. Air conditioning throttle value, 264. Air conditioning air liquid interface, 265. Air conditioning air liquid interface, 266. Thermal conductive oil interface, 267. Cold and hot medium heat exchanging device, 268. Split air conditioning heating pump, 269. Steam interface, 270. Thermal conductive oil heat storage tank, 271. Thermal conductive oil heat storage exchanging inner tank, 272. Thermal conductive oil heat exchanging device, 273. Molten salt heat exchanging device outlet, 274. Air conditioning cold and hot medium box, 275. Refrigerant heat exchanging device, 276. Air conditioning throttle value, 277. Air conditioning air liquid interface, 278. Absorption cold storage, 279. Water cold storage device, 280. Lithium bromide-water absorption/cold storage device, 281. Ammonia-water absorption/cold storage device, 282. Air conditioning air liquid interface, 283. Split air conditioning air heater, 284. Split air conditioning air liquid interface, 285. Molten salt or thermal conductive oil heat storage outer tank, 286. Molten salt or thermal conductive oil heat storage inner tank, 287. Outer/inner vacuum insulation gap, 288. Molten salt or thermal conductive oil heat storage outer tank, 289. Molten salt or thermal conductive oil heat storage inner tank, 290. High temperature insulation material, 291. Molten salt heat storage outer tank, 292. molten salt heat storage inner tank, 293. Burner, 294. Flame heat radiation sheath, 295. Flame, 296. Chimney, 297. Solid heat storage device, 298. Fire-resistant insulation brick, 299. Solid heat storage material, 306. Molten salt heat storage tank, 307. Molten salt inner heat storage tank, 308. High temperature molten salt test box, 309. High temperature box heat exchanging device, 310. High temperature box, 311. Molten salt pump, 312. Molten salt heat storage tank, 313. Molten salt inner heat storage tank 314. Molten salt heat exchanging device, 315. Molten salt heat exchanging pump, 316. Thermal conductive oil heat storage and heat exchanging tank, 317. Thermal conductive oil heat storage and heat exchanging inner tank, 318. thermal conductive oil heat exchanging pump, 319. molten salt heat storage tank, 320. Molten salt inner heat storage tank, 321. Molten salt heat exchanging device, 322. Molten salt heat exchanging device import, 323. Split air conditioning thermal conductive oil heat storage tank, 324. Split air conditioning thermal conductive oil heat storage inner tank, 325. Single-phase power supply molten salt heat storage tank, 326. Thermal conductive oil heat storage tank, 327. thermal conductive oil heat storage inner tank, 328. Thermal conductive oil circulating pump, 329. the air heater, 330. Air heater air heating heat exchanging device, 331. Inlet of the air heater, 332. Outlet of the air heater, 333. Fan, 334. Thermal conductive oil interface.

### DETAILED DESCRIPTION OF THE EMBODIMENTS

The technical solutions of the present disclosure will be clearly and completely described below with reference to the embodiments, and obviously, the described embodiments are just a part but not all of the embodiments of the present disclosure. All other embodiments obtained by a person of ordinary skill in the art based on the embodiments of This disclosure without creative efforts shall fall within the protection scope of This disclosure.

In the description of the present disclosure, it should be understood that the terms “center”, “longitudinal”, “transverse”, “length”, “width”, “thickness”, “upper”, “lower”, “front”, “rear”, “left”, “right”, “vertical”, “horizontal”, “top”, “bottom”, “inner”, “outside”, “clockwise”, “counterclockwise”, etc. are merely used to facilitate describing the present disclosure and simplify description, rather than indicating or implying that the device or clement referred to has to have a specific orientation, and is constructed and operated in a specific orientation, and therefore cannot be understood as a limitation to the present disclosure.

In addition, the terms “low temperature” and “high temperature” are used for descriptive purposes only and cannot be understood as indicating or implying relative importance or implicitly indicating the number of indicated technical features. Thus, the features defined with “low temperature “and” high temperature” may explicitly or implicitly include one or more of the features. In the description of the present disclosure, “a plurality of” means two or more, unless otherwise specifically defined. In addition, the terms “installed”, “connected” and “connected” should be understood in a broad sense, for example, may be a fixed connection, a detachable connection, or an integrated connection; may be a mechanical connection or an electrical connection.
or may be a direct connection, or may be indirectly connected by using an intermediate medium, and may be a communication inside the two elements. For those of ordinary skill in the art, the specific meanings of the above terms in the present disclosure may be understood according to specific situations.

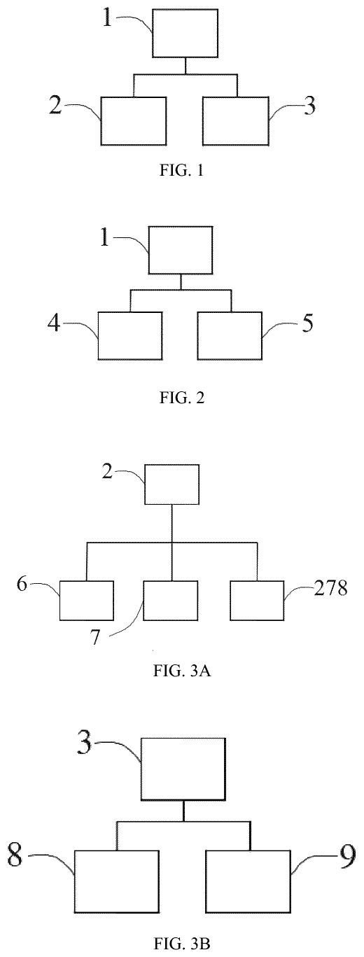

FIG. 1 is a principle diagram of according to an embodiment of the present disclosure. In FIG. 1, a block diagram is used to describe the technical solutions of the present disclosure: the energy storage means to convert the energy 1 into cold power or heat power, and perform cold storage 2 or implement the heat storage 3. Further, directly sell the cold power stored therein to the refrigeration industry, for example, the refrigeration system is used for the refrigeration system of the refrigeration compressor instead of the refrigeration compressor; or the refrigeration system of the refrigeration unit is replaced by the sales air conditioning industry as a cold source without the refrigerant, so that the refrigeration system of the existing refrigerant refrigeration compression cycle can be replaced; or the stored heat power can be directly sold for heating and heat supply system to replace the heat supply system of the fossil fuel boiler, and the heat supply industry of the existing fossil fuel boiler is replaced.

The present disclosure subverts the refrigeration technology system of the refrigerant-type refrigeration compressor, and thoroughly eliminates the world- recognized “refrigerant” that causes one of the greenhouse-effect cells. Not only is the significant environmental protection significance, but the stored energy can be directly sold as a product, so that the economic benefit is far better than that of wind power. And after the photovoltaic power generation is charged by using the battery, discharging the network for sale, or pumping and storing energy, and after the air is compressed and stored, the marketing profit for high temperatureary power generation is greater, because there is no loss of high temperatureary energy conversion. A foundation is laid for diversification and wide utilization of wind power and photovoltaic power generation energy storage, and the problem of power abandoning rate of wind power, photovoltaic power generation and power grid can be completely solved.

FIG. 1 is a schematic diagram illustrating the core technical of the present disclosure: converting the energy source 1 into two large necessities directly, ie, cold power and/or heat power. Then, the cold power is converted into the cold storage 2 product to enter the market for direct sales, or the heat power is converted into the heat storage 3 product to be directly sold in the market. Therefore, the energy loss caused by high temperatureary energy conversion is greatly avoided and reduced, the renewable energy technology development and market economy are integrated, and diversified sales channels are provided for wind power and photovoltaic power generation.

FIG. 2 is a schematic diagram of the energy according to an embodiment of the present disclosure. As shown in FIG. 2, the detailed description of the energy source 1 includes the public power grid energy electric energy 4 formed by wind power generation, photovoltaic power generation, hydroelectric generation, nuclear power generation, hydrogen energy power generation, ammonia energy power generation, and fossil fuel thermal power generation; or heat energy generated by solar energy, geothermal energy, renewable energy, industrial waste heat, and heat energy generated by fossil fuel, hydrogen combustion, ammonia combustion and biomass combustion

FIG. 3A is a schematic diagram of the cold storage according to an embodiment of the present disclosure; and FIG. 3B is a schematic diagram of the heat storage according to an embodiment of the present disclosure. The cold storage 2 in FIG. 3A is composed of a phase change cold storage 6, a sensible heat storage 7, and an absorption cold storage 278; and the heat storage 3 in FIG. 3B is composed of a phase change heat storage 8 and a sensible heat storage 9.

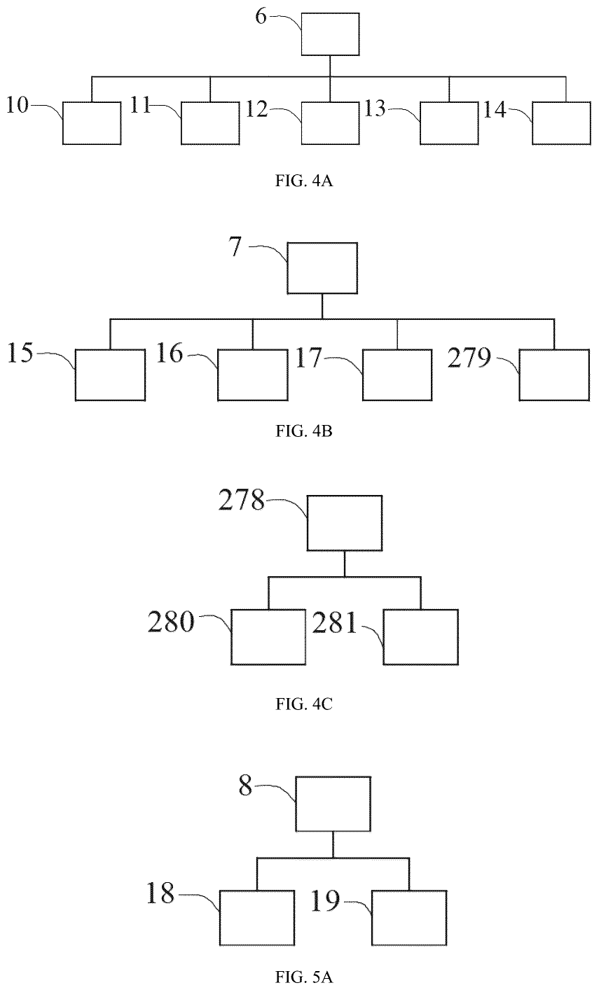

FIG. 4A to FIG. 4 C are schematic diagrams of block diagrams of phase change cold storage, sensible heat cold storage, and absorption/cold storage of the present disclosure. In FIG. 4, a liquid-air refrigeration system is proposed in the world, and the research and development center of the system uses a natural cold source-liquid space, and the replacement world uniquely relies on a refrigeration compressor, and uses a refrigeration technology of a “refrigerant” compression cycle of one of the greenhouse effect elements, so that the world enters a refrigeration era without a refrigerant. The “Barger's Ozone Layer Matter Control Protocol Protocol” is particularly limited to the refrigerant, and after the application takes effect on Jan. 1, 1989, all countries in the world have not yet developed a refrigerant that is completely free of fluorine-chlorine carbide. Under the world double-carbon target, the liquid-air refrigeration of the present disclosure will completely rewrite the history of refrigerant refrigeration.

China refrigeration industry, the manufacturing technology of the refrigeration compressor is far behind the western developed country, the used refrigeration compressor is monopolized by several foreign brand products, not only is the manufacturing technology use cost, but also the profit of the product and the purchase cost of the spare parts of the imported spare parts, and the national year is cut by the foreign quotient. In addition, the refrigeration compressor technology is complex, and generally freezing and air conditioning enterprises do not specially maintain professional technicians. Therefore, each year of training fee, dedicated operation and maintenance costs are huge.

The liquid-air refrigeration subverts the refrigeration compression mechanism to cool, and the expensive and complex refrigeration compressor system becomes a cheap liquid-empty product for storage and transportation, and is as convenient and simple as the use of tap water, so that people can use the refrigeration house system and the central air conditioner.

The liquid-air cold storage directly replaces the refrigeration compression mechanism to cool, completely eliminating the cut-off Chinese chives and the huge operation and maintenance costs. The liquid-air refrigeration is simple, safe and convenient as the faucet is opened, and it is not necessary for special personnel to perform operation and maintenance and management in any unit, and the operation cost is far lower than the refrigeration technology cost of the refrigeration compressor.

The phase change cold storage 6 in FIG. 4A contains a liquid air storage device 10, a liquid nitrogen cold storage device 11, a liquid carbon dioxide cold storage device 12, a dry ice storage device 13, and an ice storage device 14

FIG. 4B shows the oil-containing cold storage device 15, the organic-inorganic solution cold storage device 16, the anti-freezing solution cold storage 17, and the water cold storage 279 in FIG. 4B.

In FIG. 4C, the absorption type cold storage 278 contains lithium bromide-water absorption/cold storage device 280 and ammonia-water absorption/cold storage device 281.

FIG. 5A is a schematic diagram of the phase change heat storage according to an embodiment of the present disclosure, and FIG. 5B is a schematic diagram of the sensible heat storage heat according to an embodiment of the present disclosure. This disclosure is phase change heat storage core technology molten salt heat storage device. For the molten salt heat storage device, the molten salt heat storage can penetrate into all walks of life, will replace the fossil fuel boiler heating heating, and provides a comprehensive, specific application implementation, or for human heating heating technology and products, provides a grand blueprint.

This disclosure of molten salt heat storage device will subvert the fossil fuel boiler heating system, and the world has no fossil fuel boiler pollution heating era.

In FIG. 5A, the phase change heat storage 8 is composed of a molten salt heat storage device 18 or a chemical material phase change heat storage device 19. or

In FIG. 5B, the explicit heat storage 9 is composed of oil heat storage 20 or chemical solution heat storage 21 or water heat storage 22.

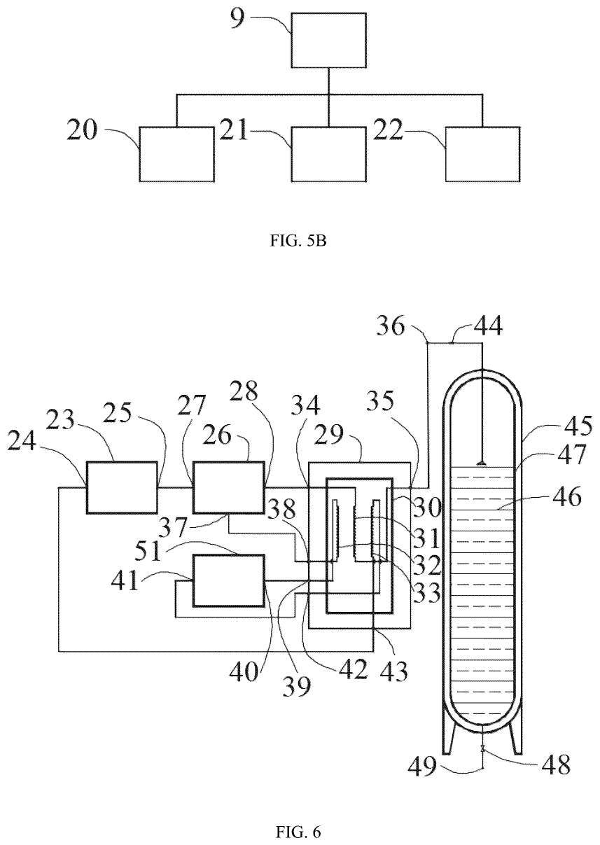

FIG. 6 is a schematic diagram of the liquid air extraction and liquid air storage according to an embodiment of the present disclosure. In FIG. 6, phase change liquid air production and cooling consists of an air compressor 23, a gas storage tank 26, a heat transfer device 29, a heat exchanging device 30, an expansion machine 51, a liquid air storage tank 45, and a liquid air 46.

The input end 24 of the air compressor 23 is in communication with the air, the output end 25 of the air compressor is connected to the input end 27 of the air storage tank, the low temperature output end 28 of the air storage tank is connected to the input end 34 of the low temperature input side, the side output end 35 of the low temperature input side is connected to the liquid air storage tank liquid filling interface 36 of the liquid storage tank, and is connected to the liquid storage tank 45 through the liquid air storage tank liquid filling shut-off valve 44 and is in communication with the liquid air. The liquid empty storage tank 45 body is provided with a liquid empty liner storage tank 47, and a gap between the liquid empty storage tank 45 body and the liquid empty liner storage tank 47 is in a vacuum adiabatic state to form a high vacuum thermal insulation structure; the high temperature output end 37 of the gas storage tank is connected to the high temperature heat exchange side input end 38, the high temperature heat exchange side output end 39 is connected to the expansion machine input end 40, the expansion machine output end 41 is connected to the super low temperature heat exchange side input end 42, and the super low temperature heat exchange side output end 43 is connected to the air compressor input end 24.

FIG. 6 shows that the air is compressed by the air compressor 23 and stored in the gas storage tank 26 and then output in two ways; the low temperature path is output to the low temperature heat exchange side 31, the high temperature path is output to the high temperature heat exchange side 32, and is transmitted to the expansion machine 51 through the high temperature heat exchange side output end 37, and the air flowing through the high temperature heat exchange side expands, so that the temperature of the high temperature heat exchange side is reduced, and meanwhile, the low temperature heat exchange side 31 is cooled; the low temperature air entering the super low temperature heat exchange side 33 is further cooled by the expansion machine output end 41 to the super low temperature heat exchange side 33, and the low temperature air entering the super low temperature heat exchange side 33 is further cooled to the low temperature heat exchange side, causing the air at the low temperature heat exchange side to be cooled to a liquid space 46 at 193° C. and stored in the liquid empty liner storage tank 47 of the liquid storage tank 45.

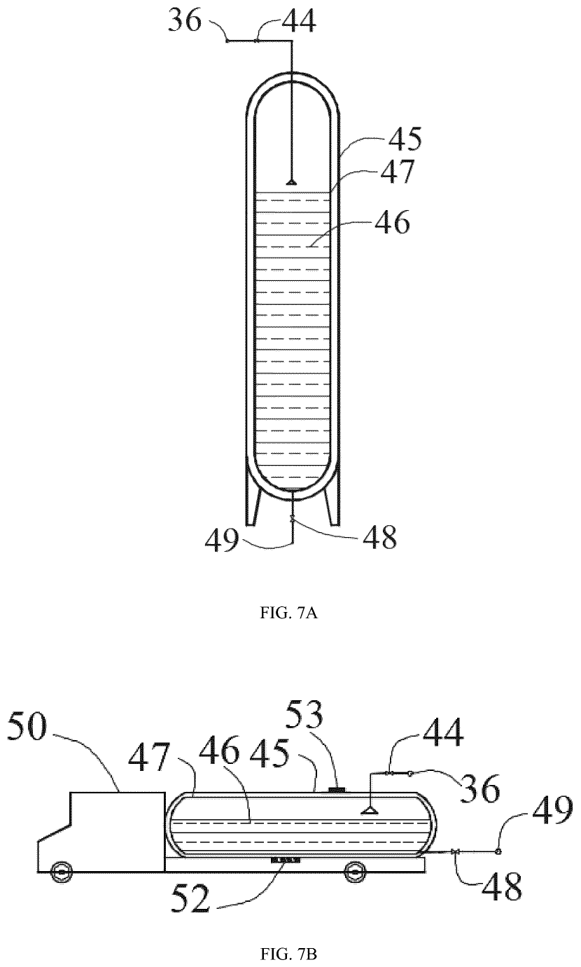

FIG. 7A is a schematic diagram of the liquid air storage according to an embodiment of the present disclosure and FIG. 7B is a schematic diagram of the liquid air storage and transportation according to an embodiment of the present disclosure. FIG. 7 is an embodiment of a liquid-air storage and liquid-air transportation of the present disclosure. FIG. 7A is a two-part of the liquid-empty storage tank 45: the low temperature part is a liquid-empty storage tank 45 housing body and a liquid-air inner container storage tank 47, and the high temperature part is an integral structure of a vacuum state, and the vacuum heat insulation principle is used to heat the cryogenic liquid at 193° C. The vacuum thermostatic technology is a British physicist Dewar, the adiabatic container of the invention in 1892, the human being commemorative, which is called the Dewar bottle in the world. Whether cold or hot liquid is stored, the temperature of the bottle can be kept unchanged for a certain period of time. The liquid empty storage tank 45 is configured in the refrigeration house and the air conditioner user side, the stored liquid space 46 is used to replace the cold source of the existing refrigerant compression cycle refrigeration process system of the refrigeration compressor, the complex refrigeration compressor unit refrigeration system becomes a simple refrigeration system which uses tap water, the refrigeration effect of the refrigeration system is far higher than the refrigeration effect of the refrigeration unit, and the cryogenic quick-freezing expensive high-difficulty technology that the refrigeration unit is difficult to implement will be simply replaced by cheap liquid-air refrigeration.

The high temperature part FIG. 7B is a motorized cold storage tank truck 50, arranging a liquid air storage tank 45 on a motor vehicle 50 to form a motorized cold storage tank truck 50. China's air separation technology is relatively mature, but at present, the basically application of liquid oxygen, liquid nitrogen, liquid argon, and liquid carbon dioxide technology and products, and there is no sales and utilization of liquid air products in the market. Therefore, the present disclosure uses the mobile cold storage tank truck 50 to fill the liquid air storage tank 45 used by the applied liquid air product user, and the liquid air 46 is distributed by the liquid air professional production plant.

FIG. 7A constitutes a liquid air storage device from the liquid filling interface 36 of the liquid air storage tank, the liquid filling stop valve 44, the liquid air storage tank 45, the liquid air storage tank storage tank 46, the liquid air inner storage tank 47, the liquid air storage tank liquid supply shut-off valve 48, and the liquid air storage tank liquid supply interface 49.

FIG. 7B shows the motorized cold storage tank truck 50, expansion machine 52, pressurizer 53, liquid air storage tank liquid filling interface 36, liquid air storage tank liquid filling stop valve 44, liquid air storage tank 45, liquid air storage tank 46, liquid air inner storage tank 47, liquid air storage tank liquid supply stop valve 48, liquid air storage tank liquid supply interface 49 constitute liquid air storage and transportation vehicle device.

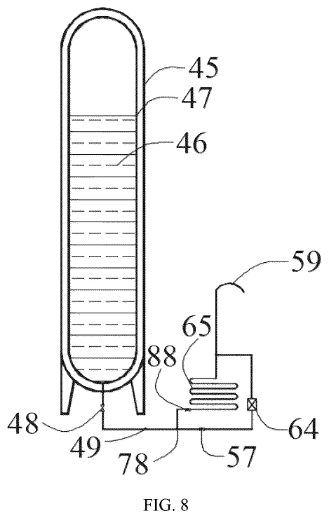

FIG. 8 is a schematic diagram of the liquid air freezing device according to an embodiment of the present disclosure. FIG. 8 is a typical cold storage device in this disclosure and is composed of liquid air storage tank 45, liquid air 46, liquid air storage tank liquid supply shut-off valve 48, coil liquid air throttle value 88, freezing coil 65 or/and air cooler liquid air cooler liquid air throttle value 57 and air cooler 64.

After opening the liquid air storage tank liquid supply shut-off valve 48 liquid air 46 enters the coil liquid air throttle value 88 through the liquid air storage tank liquid supply shut-off valve 48, the liquid air 46 expands and evaporates in the freezing coil 65, and absorbs the surrounding heat through the pipe wall of the freezing coil 65 to achieve the role of frozen articles.
or

The liquid air 46 enters the air cooler 64 through the liquid air cooler liquid air throttle value 57 through the liquid air storage tank liquid supply shut-off valve 48, expands and evaporates in the coil of the air cooler 64, absorbs the heat through the air cooler 64 to achieve the action of frozen air, and the frozen air is circulated through the fan to realize the purpose of circulating air freezing articles.

After consuming a certain amount of the liquid air, the empty liquid can be filled by the liquid air storage vehicle of FIG. 7B. For the small liquid air freezing device, the empty liquid can be filled by the liquid air storage tank of FIG. 7A.

After the above two liquid air 46 expand, evaporate and absorb heat, it is vaporized into air and discharged into the air through the air discharge outlet 59 to realize the natural liquid air 46. After freezing, it is gasified and restored to the natural atmosphere, the current double carbon green and ecological refrigeration system.

FIG. 8 shows a liquid air cold storage device, and the liquid air cold storage device overturned the existing technology using the greenhouse effect, one of the main “refrigerant” through refrigeration compressor compression cycle refrigerant refrigeration technology, and the complex refrigeration compression cycle refrigeration technology device, become only open the valve, like open tap simple and cheap, and let everyone can use affordable refrigeration technology products. FIG. 8 can be widely configured for coil refrigeration or air cooler cold storage devices, or for refrigerator freezer cold storage devices.

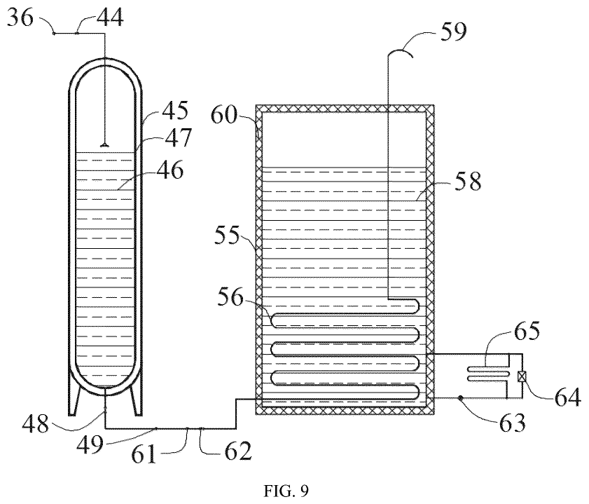

FIG. 9 is a schematic diagram of the liquid air cold storage system according to an embodiment of the present disclosure. FIG. 9 includes a classical cold storage system of liquid air storage tank 45, liquid air 46, liquid air cold storage device 55, freezing coil heat exchanging device 56, freezing medium 58, freezing coil throttle value 62, freezing medium circulating pump 63, air cooler 64 and/or freezing coil 65. Due to the cold storage room structure refrigeration pipeline system is longer, the refrigerant circulation path is too long and will cause excessive refrigerant pressure attenuation, so the existing refrigeration compression cycle refrigeration technology, mostly adopt cooling agent and use of antifreeze circulating pump cycle refrigerant method of refrigeration technology, due to the antifreeze circulating pump can long distance circulation, and the characteristics of the attenuation is small, realize the purpose of cold storage warehouse long distance efficient freezing.

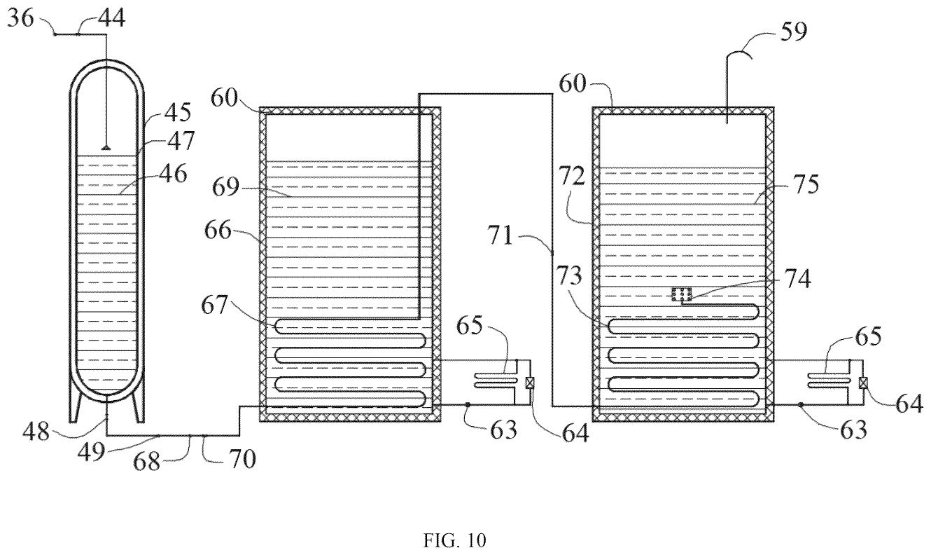

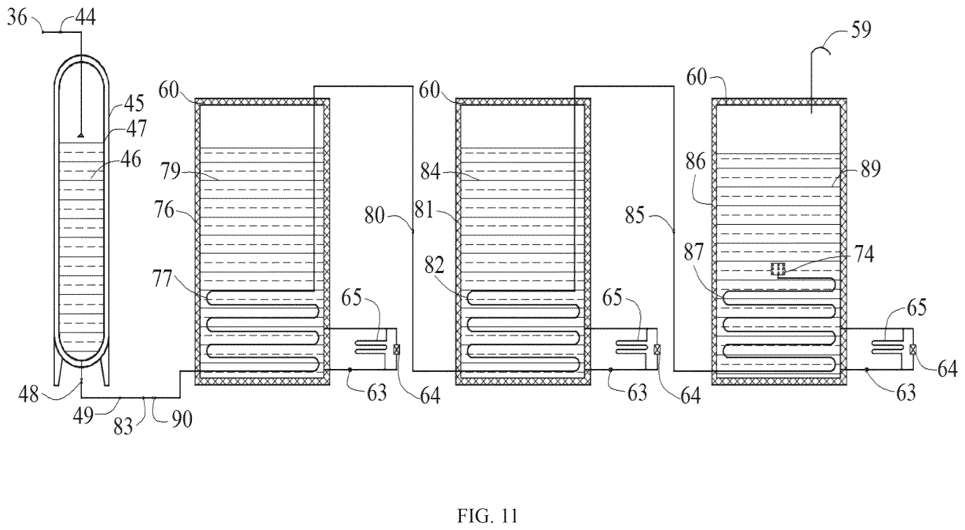

As show in FIG. 9, the freezing coil heat exchanging device 56 is immersed in the freezing medium 58, and the opening degree of the freezing coil throttle value 62 is adjusted. The liquid air 46 is expanded into the freezing coil throttle value 62 in the tube of the freezing coil heat exchanging device 56 and absorbs the heat of the chilled medium 58 through the tube wall, and uses the chilled medium circulating pump 63 through the air cooler 64 and/or the freezing coil 65 to achieve a purpose of freezing the cold storage building. Generally, the circulation of air in the air cooler is easy to cause food drying, but the freezing speed is fast, which is often configured for food freezing application in the freezing room of the cold storage. The freezing coil is often used in the cold storage room, because its water consumption is slower than the air cooler, which is better for food refrigeration for a long time. Therefore, the cold storage and freezer in the freezing coil and air cooler mixed use is more classic. The technical solution shown in FIG. 9 can be widely used in cold storage and as classical cryogenic systems in freezing devices, because the cooling agent is circulated through the freezing medium circulating pump 63, and can deliver cold sources uniformly over a long distance with low attenuation. FIG. 10 is a schematic diagram of the embodiment of the high temperature liquid air cold storage fresh storage according to an embodiment of the present disclosure. As show in FIG. 10, the cold storage system includes the liquid air storage tank 45, the liquid air 46, the liquid air cryogenic cold storage device 66, the low temperature refrigeration coil heat exchanging device 67, the low temperature freezing medium 69, the low temperature coil throttle value 70, the high temperature coil throttle value 71, the high temperature liquid air cold storage device 72, the high temperature freezing coil heat exchanging device 73, the gas-liquid mixer 74, and the high temperature freezing medium 75.

In FIG. 10, the liquid air cold storage device 66 saves the freezing medium 69 to −18° C. through the low temperature refrigerated coil heat exchanging device 67, and the high temperature liquid air refrigerated storage device 72 saves the high temperature refrigerated coil heat exchanging device 73 and the high temperature refrigerated medium 75 to 5° C.

The gas-liquid mixer 74 in FIG. 10 is used to save liquid air 46. After evaporation through the low temperature liquid air cold storage device 66, the temperature of the high temperature freezing coil heat exchanging device 73 of the high temperature cool the high temperature cooling medium 75 to the temperature of the high temperature freezing medium 75, and to control the temperature of the high temperature freezing medium 75 at about 2° C. to 5° C., and the gasified air is discharged through the air discharge port 59 to save the amount of liquid air cooling.

FIG. 11 is a schematic diagram of the super low temperature liquid air cold storage freezing, the low temperature cold storage, and the high temperature fresh storage refrigeration system according to an embodiment of the present disclosure. As shown in FIG. 11, the super low temperature liquid air cold storage freezing, the low temperature cold storage, and the high temperature fresh storage refrigeration system are constituted by the liquid air storage tank 45, the liquid air 46, the super low temperature liquid air freezing cold storage device 76, the super low temperature freezing coil heat exchanging device 77, the super low temperature throttle value 90, the cold storage device 81, the low temperature freezing coil heat exchanging device 82, the low temperature freezing medium 80, the high temperature liquid air cold storage device 86, the high temperature freezing coil heat exchanging device 87, the high temperature freezing medium 89, the high temperature throttle value 85, and the liquid mixer 74.

The liquid air 46 is fed into the super low temperature throttle value 90 through the freezing liquid air interface 83, and evaporate into the super low temperature freezing coil heat exchanging device 77, and absorb the heat of the super low temperature freezing medium 79 and freeze it into −40° C. After the evaporated liquid enters the low temperature freezing coil heat exchanging device 82 to absorb the heat and freezing into −18° C. After the high temperature evaporation, the liquid air is throttled through the high temperature throttle value 85, and further evaporate through the high temperature freezing coil heat exchanging device 87, and continues to absorb the heat in the high temperature freezing medium 89 and freeze it into 5° C. The medium of each corresponding temperature is frozen by the respective freezing medium circulating pump 63 through the air cooler 64 and/or freezing coil 65 to realize a multi-temperature cold storage embodiment.

The temperature of the “super low temperature” cold storage is −23° C., but the applicant believes that the temperature should be innovated as −40° C. for freezing, so that the quick-frozen food can be sent to cold storage, and its quality is more delicious. However, the existing technology to reach −40° C. is more expensive, and difficult to achieve. However, the super low temperature of about −40° C. is very easy and very cheap to achieve for the liquid air of −193° C., which is the advantage of liquid air refrigeration. Therefore, the economic value and environmental protection significance of the liquid air refrigeration system technology described in this disclosure are inestimable.

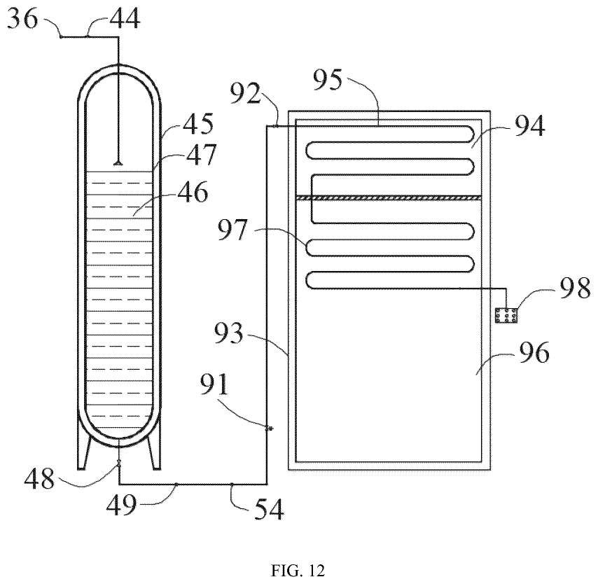

FIG. 12 is a schematic diagram of the liquid air refrigerator and freezer according to an embodiment of the present disclosure. As shown in FIG. 12, the liquid air refrigerator refrigerator consists of the empty storage tank 45, the liquid air 46, a freezer solenoid valve 91, a liquid air refrigerator 93, a refrigerated container 94, a refrigerated coil 95, a fresh keeping tank 96, a high temperature coil 97 and an freezer air outlet 98 the refrigerator refrigerator.

As shown in FIG. 12, the freezer solenoid valve 91 forms an automatic control device of the liquid air 46, thus to realize the automatic temperature control system of the refrigerator. The temperature of the refrigeration box 94 is controlled at −18° C., and fresh-keeping box 96 is controlled at 5° C.

The working principle of the air discharge outlet of the freezer air outlet 98 is basically the same as the air discharge outlet 59 described in FIG. 8, which is air discharge. However, because the refrigerator is for indoor application, so the air discharge outlet of the freezer air outlet 98 should be manufactured into a low-noise structure to achieve the indoor silent operation.

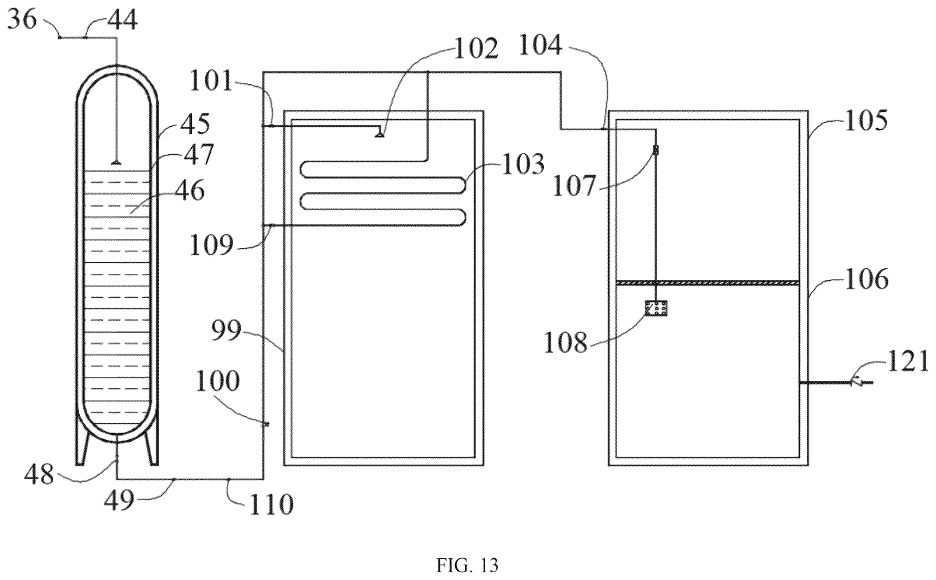

FIG. 13 is a schematic diagram of the ultra-low temperature, the super low temperature and the low temperature liquid air test box according to an embodiment of the present disclosure. FIG. 13 shows a liquid air test box, which includes the liquid air storage tank 45, the liquid air 46, a ultra-low temperature liquid air freezing device 99, a ultra-low temperature freezing throttle value 101 and/or a ultra-low temperature coil throttle value 109, a liquid air spraying nozzle 102 and/or a liquid air spraying nozzle 103, a super low temperature liquid air freezing device 105, a low temperature liquid air freezing device 106, an air cooler 107, a low temperature liquid air releasing device 108, and an air check valve 121.

As shown in FIG. 13, the ultra-low temperature liquid air freezing device 99 uses the liquid air spraying nozzle 102 to directly spray the liquid air 46, rapidly freeze test items; and/or uses the special ultra-low temperature freezing coil 103 for freezing for a long tine, and the temperature can easily obtain the special ultra-low temperature environment of −80° C. to −193° C., completely subverting the existing technology refrigerant compression cycle difficult to achieve and unimaginable expensive refrigeration test device, so that everyone can get the special low temperature experimental device cheaply for scientific experiments.

The super low temperature liquid air freezing device 105 is equipped with an air cooler 107 and/or a super low temperature freezing coil 109, and adjusts the super low temperature throttle value 104 to control the temperature of the super low temperature liquid air freezing device 105 from −80° C. to −40° C. to conduct a super low temperature test.

The low temperature liquid air freezing device 106 is equipped with a low temperature liquid air releasing device 108 and the air cooler 107, and the super low temperature liquid air freezing device 105 continues to release the cryogenic volume through the low temperature liquid air releasing device 108 to directly get a low temperature to −40° C. to −10° C. Since the liquid air in the low temperature liquid air freezing device 106 is directly released through the low temperature liquid air releasing device 108, there is a certain pressure in the low temperature liquid air freezing device 106. In order to prevent the temperature of the experimental device from the ambient temperature, the air check valve 121 is provided to exhaust air inward.

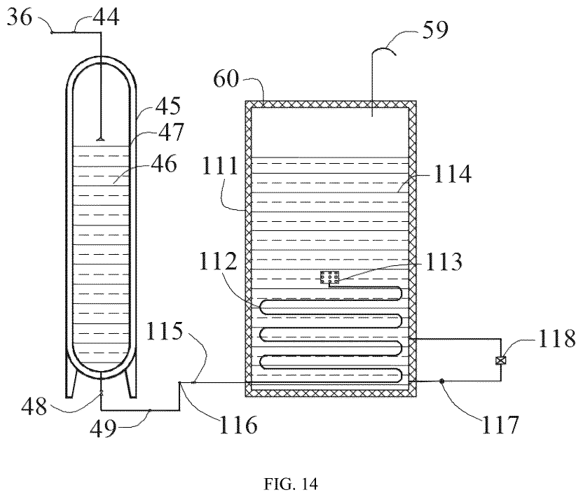

FIG. 14 is a schematic diagram of the liquid air air conditioning cold water refrigeration system according to an embodiment of the present disclosure. As shown in FIG. 14, a classic refrigeration compression cycle chiller central air conditioning system is formed by the liquid air storage tank 45, an liquid air air conditioning cold storage device 111, a gas-liquid mixer 113, chilled water 114, air conditioning coil throttle value 115, an air conditioning circulating pump 117, and a fan coil air conditioner 118. However, the liquid air chilled water device in this disclosure completely subverts the expensive and complex central air conditioning technology of chiller. In all walks of life, we no longer need to rely on refrigeration professionals, high operation and maintenance costs, and the technology is difficult for users to master the refrigeration compression chiller air conditioning system. The world can afford cheap gas-liquid central air conditioning system.

As shown in FIG. 14, the liquid air 46 enters the air conditioning coil heat exchanging device 112 through the air conditioning liquid air interface 116 and the air conditioning coil throttle valve 116, and expands the heat in the air conditioning coil heat exchanging device 112. After pass by the gas-liquid mixer 113, the air releases the remaining low temperature air to the air or to the air conditioning room to save the cooling amount of the liquid air 46. The air conditioning refrigerant cooling the chilled water 114 to 7° C., with the uses of the air conditioning circulating pump 117 and the fan coil air conditioner 118 to realize the cooling air conditioning operation.

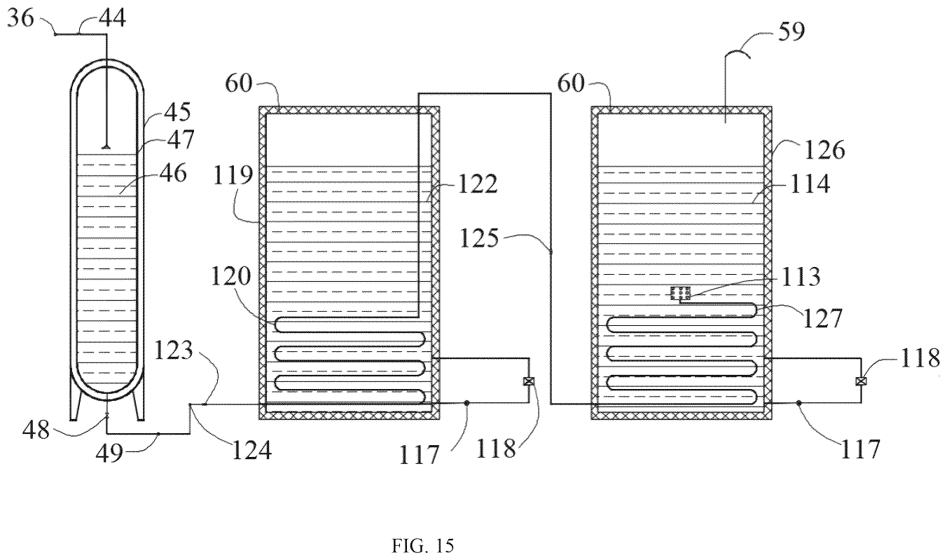

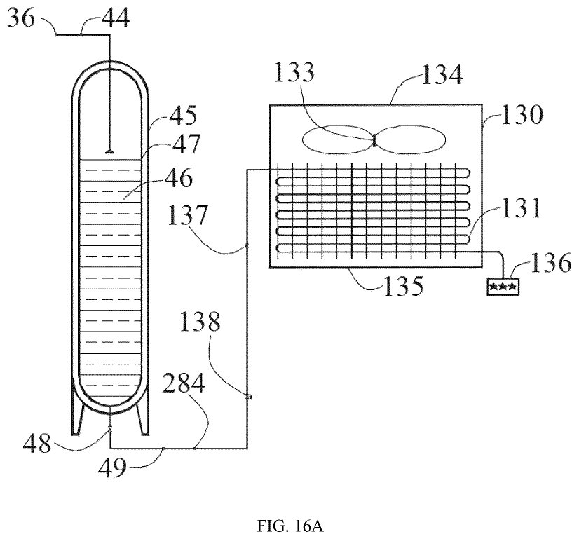

FIG. 15 is a schematic diagram of the liquid air with the chilled water at 2° C. and 7° C. of a super central air conditioning refrigeration system according to an embodiment of the present disclosure. FIG. 15 shows the super central air conditioning refrigeration system, includes the liquid air storage tank 45, the liquid air 46, the low temperature air conditioning coil storage device 119, the low temperature coil heat exchanging device 120, the low temperature chilled water 122, the air conditioning throttle value 125, an air conditioning storage device 126, an air conditioning coil heat exchanging device 127, the gas-liquid mixer 113, the air conditioning chilled water 114, the air conditioning circulating pump 117, and the fan coil air conditioner 118.

The generally chilled water temperature of the existed technology compression refrigeration circulating air conditioning system is 7° C., but as the greenhouse weather is more and more hot, water temperature air conditioning of 2° C. has more excellent, however effect. While the existing technology compression refrigeration circulating air conditioning system for 2° C. water temperature is not easy, due to the accuracy of the automatic control system, and the chiller heat exchanging device heat delay, it is easy to cause the unit freezing accident, therefore, the chiller antifreeze temperature point set to 2° C., all 2° C. chilled water for compression refrigeration unit is difficult to achieve. However, 2° C. liquid air chilled water is very simple and easy.

As shown in FIG. 15, the low temperature air conditioning storage device 119 produces 2° C. chilled water, and the 2° C. chilled water is sent to the low temperature floor or the higher floor that in high room temperature by the fan coil air conditioner 118; 7° C. chilled water is sent to the lower room temperature floor of the building for cross configuration, and the air conditioning effect is better, or all 2° C. chilled water is used.

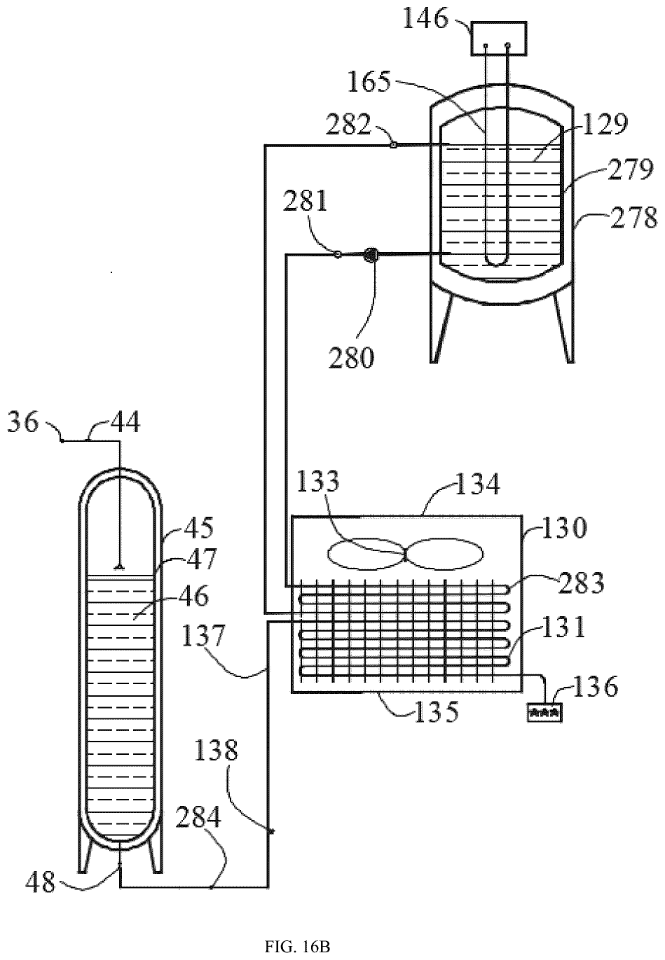

FIG. 16A and 16B are schematic diagrams of liquid air refrigeration and/or conductive oil heating split air conditioning according to an embodiment of the present disclosure.

FIG. 16A shows a liquid split air conditioner consisting of the liquid air storage tank 45, the liquid air 46 and the liquid air split air conditioner 130. The liquid air split air conditioner 130 is composed of the coil surface air cooler 131 and the fan 133; the liquid air storage tank 45 and liquid air 46 are arranged in an indoor or outdoor safer position.

When the liquid air split air conditioner is working, the liquid air 46 enters through the split air conditioner throttle value 137 to absorb the air heat in the air conditioning room, and the cooling air is blown in the room through the fan 133, to realize the aim of air conditioning cooling.

A split air conditioning liquid air releasing port 136 is placed outside, constitute discharge outlet of rain, dust, and low noise air.

Liquid air split air conditioning is cheap, simple, environmentally friendly, pure natural ecological air conditioning. or

The liquid air split air conditioner 130 of FIG. 16B includes coil surface air cooler 131, the fan 133, a split air conditioning thermal conductive oil heat storage tank 323, a split air conditioning thermal conductive oil heat storage inner tank 324, the electric heating device 165, the thermal conductive oil 129, the air heater 283, and split air conditioning heating pump 268.

The liquid air split air conditioner of FIG. 16B can completely replace the existing split heat pump air conditioner. The winter heating is stored by the split air conditioning thermal conductive oil heat storage tank 323, circulating by the split air conditioning heating pump 268 and the thermal conductive oil 129 is passed by thermal oil conductive interface 266, and the thermal conductive oil 129 finally is circulated to the split air conditioning air heater 283, thus the air in the air conditioning room is heated by the fan 133. The heating oil 129 is reheated by the thermal conductive oil interface 334 and the circulate back to the thermal conductive oil storage tank 323, and the above cycle is repeated.

The heat resources of FIG. 16B can also replaced by a molten salt storage heat, the thermal conductive oil storage tank 323 is adopted by considering split air conditioning is not long-term, continuous use. However, once the molten salt stop power supply will cure, start again melting difficult, will bring inconvenience to split air conditioning, using thermal conductive oil is not affected by power supply outage, easy to switch on and off, making liquid air separation air conditioning is easy to use, safe and reliable.

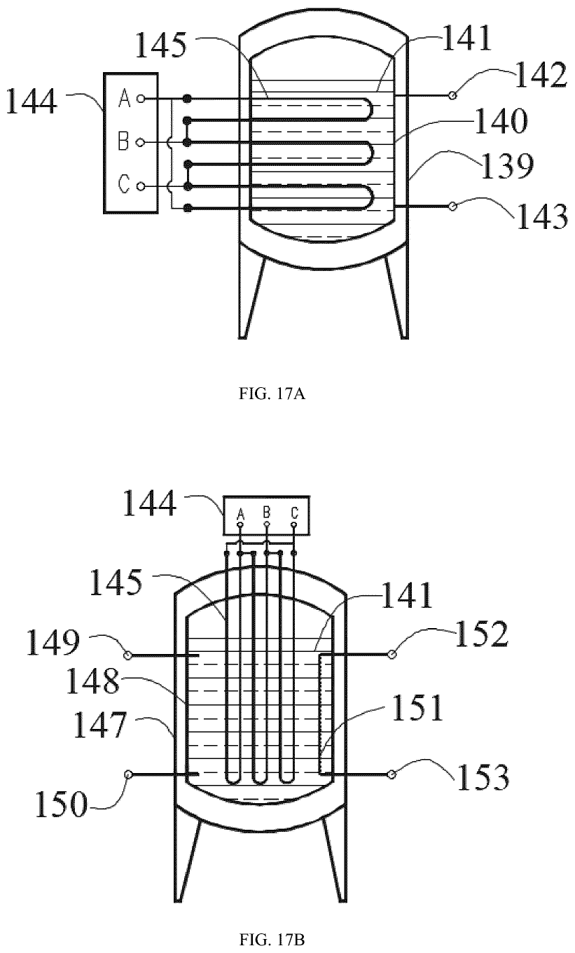

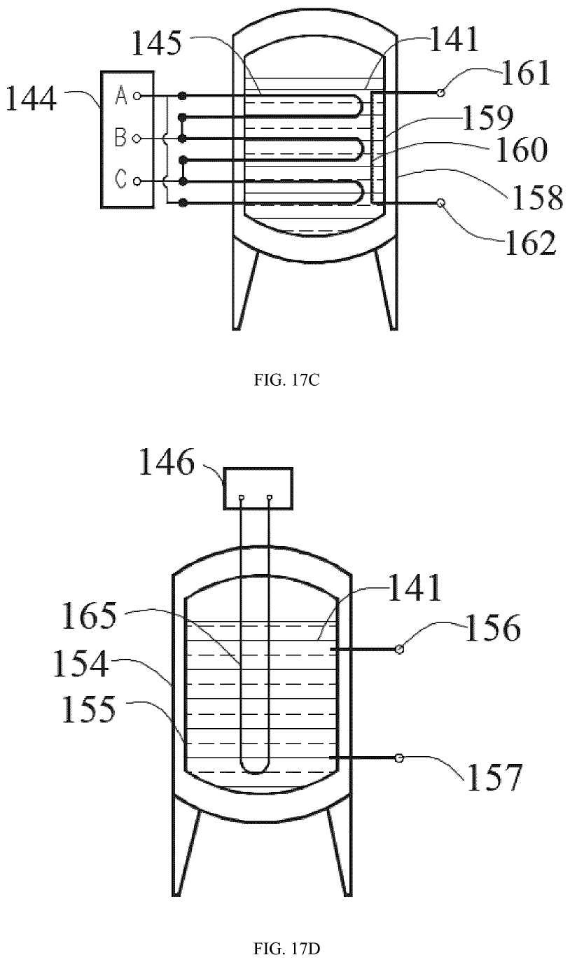

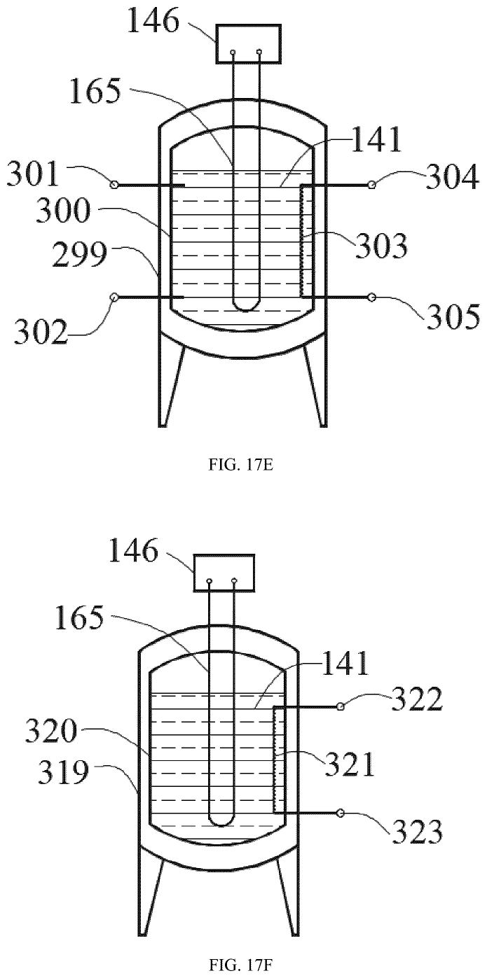

FIGS. 17A to F are schematic diagrams of the heat reservoir embodiment of this disclosure.

FIG. 17A is a schematic diagram of the molten salt power electric heat storage with molten salt interface according to an embodiment of the present disclosure. In FIG. 17A, the molten salt heat storage device 18 includes a body of the molten salt heat storage tank body 139, a molten salt inner heat storage tank 140, a molten salt 141, anelectric heating device 145, molten salt output interface 142, and a molten salt input interface 143.

The molten salt heat storage tank 139 is equipped with the molten salt inner heat storage tank 140, and the molten salt 141 is provided with the molten salt inner heat storage tank 140, and the electric heating device 145 is immersed in the molten salt 141. After being supplied by the power source 144, the molten salt 141 is heated by the electric heating device 145 and is melted from a solid phase into a liquid molten salt. Molten salt is a very ideal heat storage material, solid state is powder, heated to the melting point temperature 142° C. phase change to liquid, the highest can reach about 600° C. temperature storage, and the pressure change is not large, excellent fluidity, heat output from the molten salt output interface 142 and molten salt input interface 143 through the molten salt pump cycle. It is also reported that the maximum temperature of molten salt reaches 1000° C., which is good for heat storage. The heat storage device can make a smaller volume and store more energy, but the cost of its equipment and materials will also be higher. Therefore, or the comprehensive consideration of the cost performance is better.

The molten salt heat storage tank in this disclosure will subvert the fossil fuel boiler heating and heating system, and develop a widely used implementation that will replace all fossil fuel boilers. May the world have no fossil fuel boilers heating the era.

FIG. 17B is a schematic diagram of the molten salt power electric heat storage with molten salt interface and heat exchanging device according to an embodiment of the present disclosure. The molten salt power electric heat storage of FIG. 17B includes a body of the molten salt heat storage tank 147, a molten salt inner heat storage tank 148, the molten salt 141, the electric heating device 145, the molten salt input interface 149, the molten salt outlet interface 150, and the molten salt coil heat exchanging device 151 to form the power electric heat storage with molten salt interface and heat exchanging device type molten salt storage tank.

FIG. 17B provides the molten salt heat exchanging device 151 in the molten salt storage tank on the basis of FIG. 17A, which is more convenient and practical for heat storage and heat output.

FIG. 17C is a schematic diagram of the molten salt power electric heat storage with heat exchanging device according to an embodiment of the present disclosure. FIG. 17C shows the molten salt power electric heat storage consists of the molten salt heat storage tank 158, the molten salt heat storage tank 159, the molten salt 141, the electric heating device 145 and molten salt heat exchanging device 160.

The electric heating device 145 is immersed in the molten salt 141, and the molten salt heat exchanging device 160 is immersed in the molten salt 141.

FIG. 17D is a schematic diagram of the molten salt single-phase electric heat storage with molten salt interface according to an embodiment of the present disclosure. As shown in FIG. 17 the molten salt single-phase electric heat storage includes the molten salt heat storage tank 154, molten salt inner heat storage tank 155, molten salt 141, electric heating device 165, molten salt output interface 156, molten salt input interface 157. The molten salt 141 is configured in the molten salt inner heat storage tank 155 of the molten salt heat storage tank 154. And the electric heating device 145 is immersed into the molten salt 141, the molten salt heat storage tank 154 is provided in the molten salt output interface 156 and communicated with the molten salt 141. The molten salt heat storage tank 154 is provided in the molten salt input interface 157 and communicated with the molten salt 141. The molten salt single-phase electric heat storage of FIG. 17D can be widely used in the domestic heat storage and can replace the prior art fossil fuel heating and heating system.

FIG. 17E is a schematic diagram of the molten salt single-phase electric heat storage with molten salt interface and heat exchanging device according to an embodiment of the present disclosure. Specifically, the molten salt heat storage device includes a single-phase power supply molten salt heat storage tank 325, a single-phase power supply molten salt heat storage tank tank 300, the molten salt 141, the electric heating device 165, molten salt input interface 301, the molten salt output interface 302, the molten salt heat exchanging device 303, the molten salt heat exchanging device input interface 304 and the molten salt heat exchanging device output interface 305.

The single-phase power supply molten salt heat storage tank 325 is provided with the single-phase power supply molten salt heat storage tank tank 300, the molten salt 141 is put in the single-phase power supply molten salt heat storage tank 300, and the electric heating device 165 is immersed in the molten salt 141. The single-phase power supply molten salt storage tank 325 is provided with the molten salt input interface 301 and communicated with the molten salt 141, and the single-phase power supply molten salt storage tank 325 is provided with the molten salt output interface 302 and communicated with the molten salt 141. The molten salt heat exchanging device 303 is immersed in the molten salt 141.

FIG. 17F is a schematic diagram of the molten salt single-phase electric heat storage with heat exchanging device according to an embodiment of the present disclosure. As shown in FIG. 17, the molten salt single-phase electric heat storage includes the molten salt heat storage tank 319, the molten salt storage tank 320, the molten salt 141, the electric heating device 165 and the molten salt heat exchanging device 321.

The molten salt 141 is disposed in the molten salt inner heat storage tank 320, the electric heating device 165 is immersed in the molten salt 141, and the molten salt heat storage tank 319 is provided with the molten salt heat exchanging device 321 and is immersed in the molten salt 141.

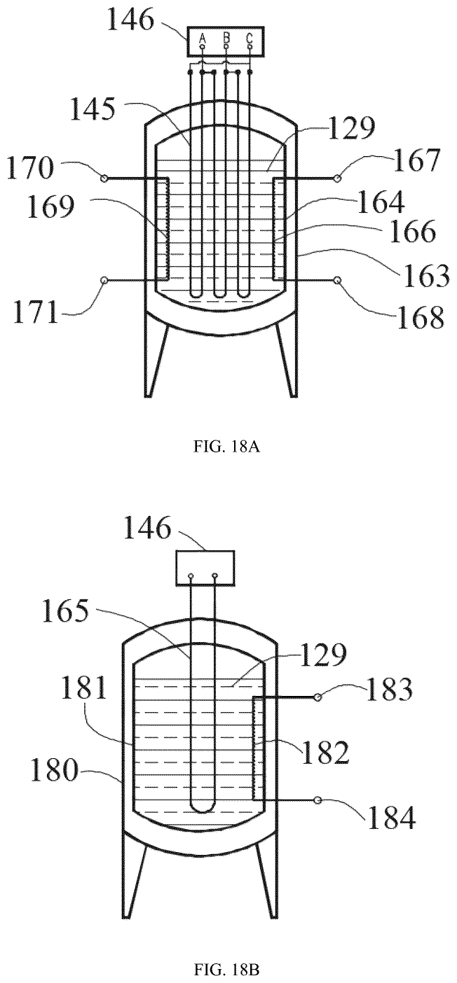

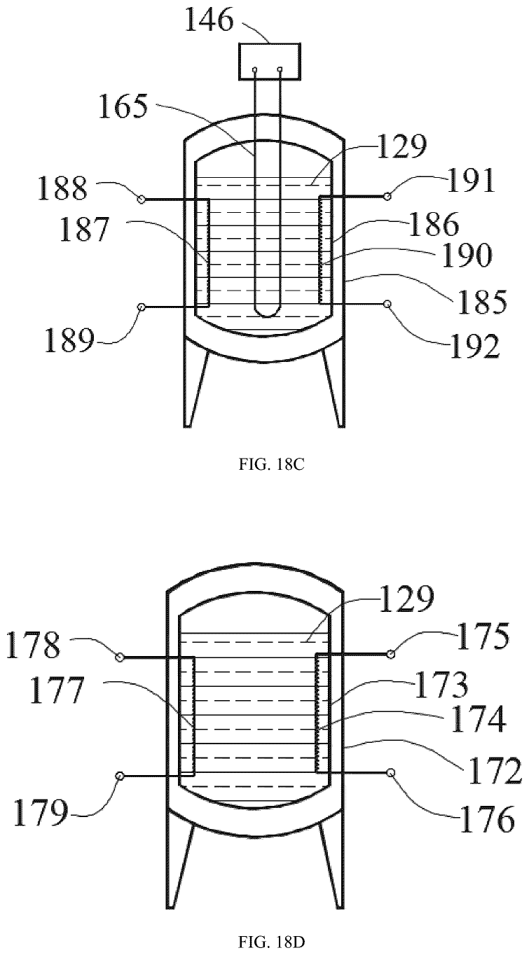

FIG. 18A is a schematic diagram of the thermal conductive oil power electric heat storage with heat exchanging device according to an embodiment of the present disclosure. As shown in FIG. 18, the power electric oil heat storage device 20 is composed of the oil heat storage tank 163, the oil inner heat storage tank 164, the low temperature oil heat exchanging device 166 and/or the high temperature oil heat exchanging device 169, the thermal conductive oil 129 and the electric heating device 145. In FIG. 18A, the low temperature oil heat exchanging device 166 and/or the high temperature oil heat exchanging device 169 are immersed in the thermal conductive oil 129 and the electric heating device 145 is immersed in the thermal conductive oil 129.

In FIG. 18A, thermal conductive oil is a common name for high temperature thermal conductive oil in the world. At a temperature of about 350° C., it is not only a good thermal conductivity, but also an excellent heat exchange medium. Its heat storage effect is also very ideal, not only the pressure does not increase significantly, and the liquidity is excellent. But when the temperature is higher than 400° C., the thermal conductive oil will carbonize, therefore, when applied in actual, it should not exceed more than 400° C.

FIG. 18B is a schematic diagram of the thermal conductive oil single-phase electric heat storage with heat exchanging device according to an embodiment of the present disclosure. As shown in FIG. 18B, the thermal conductive oil single-phase electric heat storage includes an oil storage tank 180, an oil tank heat storage tank 181, an oil heat exchanging device 182 and the electric heat device 165. In FIG. 18B, the electric heating device 165 and the oil heat exchanging device 182 are immersed in the thermal conductive oil 129 and applied to the heat storage and heat exchanging tanks.

FIG. 18C is a schematic diagram of the thermal conductive oil single-phase electric with heat exchanging heat storage tank according to an embodiment of the present disclosure. As shown in FIG. 18C, the thermal conductive oil single-phase electric heat storage with heat exchanging device includes the oil storage tank 185, oil inner heat storage tank 186, the low temperature oil heat exchanging device 187, and/or the high temperature oil heat exchanging device 190, the thermal conductive oil 129, and the electric heating device 165.

In FIG. 18C, the low temperature oil heat exchanging device 187 and/or the high temperature oil heat exchanging device 190 are immersed in the thermal conductive oil 129 and applied in the heat storage and heat exchanging tanks.

FIG. 18D is a schematic diagram of the thermal conductive oil heat exchanging device according to an embodiment of the present disclosure. As shown in FIG. 18D, the thermal conductive oil heat exchanging device includes a thermal conductive oil heat transfer device by an oil heat storage and heat exchanging tank 172, an oil heat storage and heat exchanging inner tank 173, a low temperature oil heat exchanging device 174 and/or a high temperature oil heat exchanging device 177 and the thermal conductive oil 129. In FIG. 18D, the low temperature oil heat exchanging device 174 and/or the high temperature oil heat exchanging device 177 are immersed in thermal conductive oil 129.

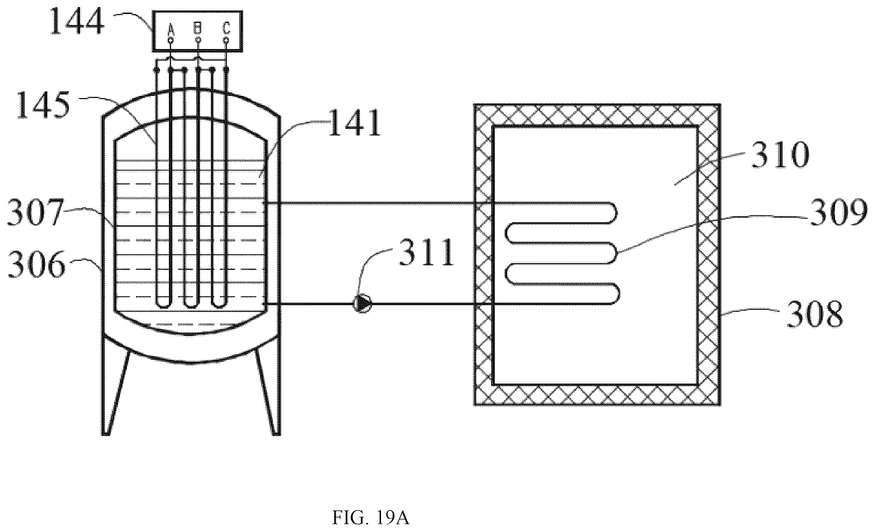

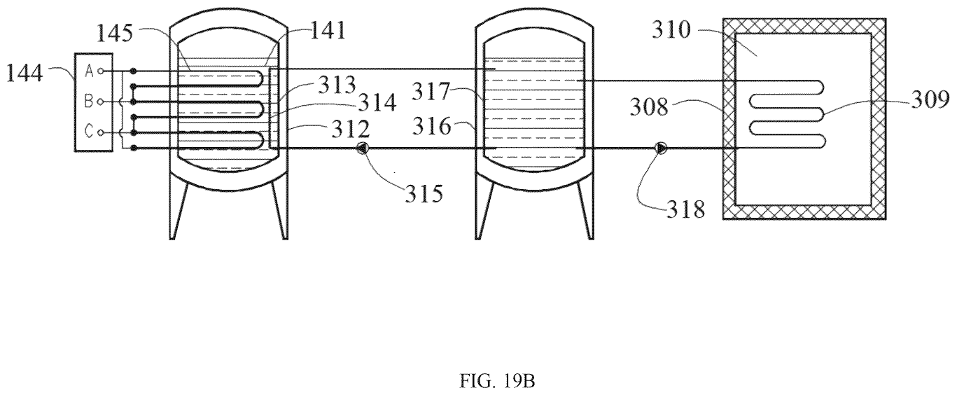

FIGS. 19A and 19B are schematic diagram of the high temperature molten salt heat storage hardening furnace and test box according to an embodiment of the present disclosure. As shown in FIG. 19A, the high temperature molten salt heat storage hardening furnace includes a molten salt heat storage tank 306, molten salt inner heat storage tank 307, a high temperature molten salt test tank 308, a high temperature box heat exchanging device 309, a high temperature tank 310, a molten salt pump 311, a molten salt 141 and the electric heating device 145.

In FIG. 19A, the solid molten salt 141 becomes liquid molten salt 141 after heating by the electric heating device 145, and circulated into the high temperature box heat exchanging device 309 through the molten salt pump 311, and heated the high temperature box 310 through the high temperature box heat exchanging device 309. The over cooled liquid molten salt 141 is recycled into the molten salt heat storage tank 306, with repeated cycle heating.
or

As shown in FIG. 19B, the high temperature molten salt heat storage test box includes a molten salt heat storage tank 312, a molten salt heat storage tank 313, the molten salt 141, the electric heating device 145, a molten salt heat exchanging device 314, a thermal conductive oil heat storage and heat exchanging tank 316, a thermal conductive oil heat storage and heat exchanging inner tank 317, a thermal conductive oil heat exchanging pump 318, a high temperature molten salt testing tank 308, a high temperature tank heat exchanging device 309, a high temperature box 310, the thermal conductive oil 129, and the molten salt heat exchanging pump 315.

In FIG. 19B, the liquid molten salt 141 enters the molten salt heat tank 312 and heats the molten salt heat exchanging device 314. After the thermal conductive oil 129 circulated by the molten salt heat exchanging pump 315 enters the molten salt heat exchanging device 314, the thermal conductive oil 129 is Heated by a liquid molten salt 141. The overheated thermal conductive oil 129 cycle enters the thermal conductive oil heat storage and heat exchanging tank 316 for cycle, and constantly heated to high temperature by the molten salt heat exchanging device 314. And store the heat in the thermal conduction oil 129, high temperature thermal conductive oil 129 cycle into the high temperature box heat exchanging device 309 by thermal conductive oil heat exchanging pump 318 to release heat. Heating the high-temperature box 310, and over cooled thermal conductive oil 129 is recycled to thermal conductive oil heat storage and heat exchanging tank 316, the thermal conductive oil 129 continues to be circulated by the molten salt heat exchanging device pump 315 and reenters the molten salt heat exchanging device 314 for cyclic heating utilization.

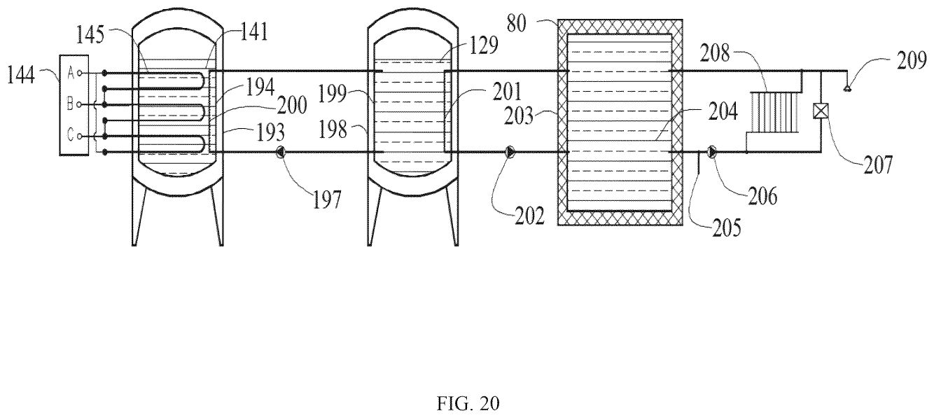

FIG. 20 is a schematic diagram of the molten salt heat storage and heating and bath system according to an embodiment of the present disclosure. As shown in FIG. 20, the molten salt heat storage and heating and bath system consists of molten salt heat storage tank 193, the molten salt heat storage inner tank 194, the molten salt 141, the electric heating device 145, the thermal conductive oil heat exchanging tank 198, the thermal conductive oil heat exchanging inner tank 199, the thermal conductive oil 129, the molten salt heat exchanging pump 197, a molten salt heat exchanging device 200, a thermal conductive oil heat exchanging device 201, a thermal conductive oil heat exchanging pump 202, a heat storage tank 203, hot water 204, a hot water circulating pump 206, a fan coil air conditioner 207 and/or a radiator 208 or a shower 209.

In FIG. 20, the hot water 204 circulated by the thermal conductive oil heat exchanging pump 202 circulates into the conductive oil heat exchanging device 201, the thermal conductive oil 129, and continuously heated by the hot water circulating pump 206, through the fan coil air conditioner 207 and/or the radiator 208 or the shower 209, heating or bath.

The molten salt heat storage and heating and bath system of FIG. 20 may be applied in a heating, bath system; or an independent bath center as a domestic hot water supply system.

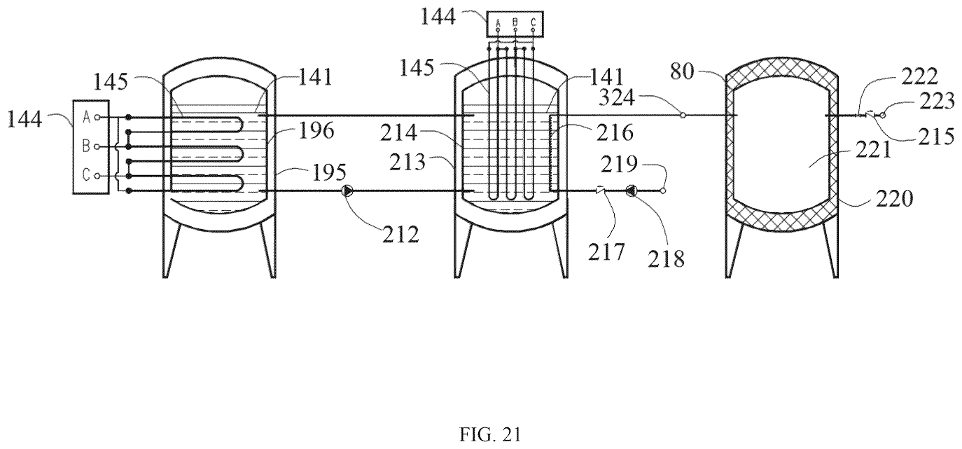

FIG. 21 is a schematic diagram of the molten salt heat storage steam system according to an embodiment of the present disclosure. As shown in FIG. 21, the molten salt heat storage steam system includes a high temperature molten salt heat storage tank 195, a molten salt heat storage inner tank 196, the molten salt 141, a molten salt circulating pump 212, the electric heating device 145, a low temperature molten salt heat storage tank 213, a low temperature molten salt heat storage and heat exchanging inner tank 214, a steam generator 216, a pump 218, a water interface 219, a steam storage tank 220, steam 221, a steam output interface 223, and a steam input interface 269.

As shown in FIG. 21, the high temperature molten salt heat storage tank 195 can heat and store heat to a high temperature of 600° C., and the purpose is to store heat. The low temperature molten salt heat storage tank 213 can heat and store heat the temperature of 200° C., and the temperature can also be confirmed according to the steam temperature requirements to melt the molten salt 141 to facilitate flow and circulation.

In FIG. 21, water is added to the steam generator 216 through the pump 218 and the check valve 217. Since the molten salt 141 in the low temperature molten salt heat storage tank 213 is at a temperature of 200° C. and is heated, and heating the steam 221. And the steam 221 is pass through the steam input interface 269 and is added to the steam storage tank 220 and be stored. Further, the steam 221 is output by the steam output interface 223. The steam pressure and dryness are automatically controlled by the temperature control of the low temperature molten salt heat storage tank 213.

As shown in FIG. 21, the steam technology of molten salt heat storage tank subverts the existing steam boiler heating and can replace the fossil fuel boiler steam system. May there be no fossil fuel boiler heating, heating era.

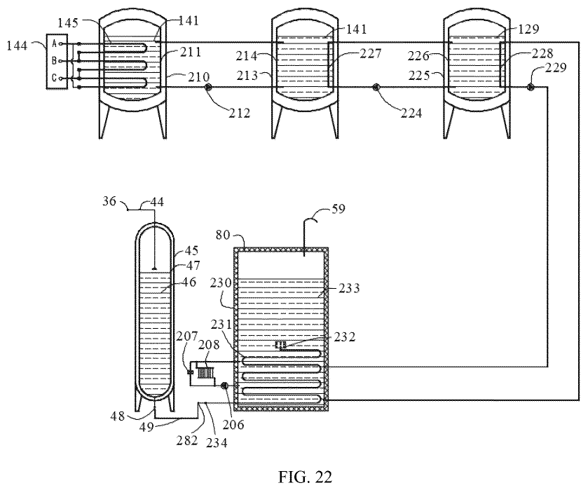

FIG. 22 is a schematic diagram of the liquid air refrigeration and molten salt heating central air conditioning system according to an embodiment of the present disclosure. As shown in FIG. 22, the liquid air refrigeration and molten salt heating central air conditioning system includes the liquid air storage tank 45, the liquid air 46, the high temperature molten salt heat storage device 210, the high temperature molten salt storage inner tank 211, the molten salt 141, a molten salt circulating pump 212, a electric heating device 145, a low temperature molten salt heat storage tank 213, a low temperature molten salt heat storage and heat exchanging inner tank 214, a low temperature molten salt heat exchanging pump 224, a thermal conductive oil storage heat exchanging tank 225, a thermal conductive oil heat storage and heat exchanging tank 226, a low temperature molten salt heat exchanging device 227, a thermal conductive oil heat exchanging device 228, a heat exchanging pump 229, an air conditioning medium 230, a liquid air heat exchanging device 231, an air water mixer 232, an air conditioning hot and heat medium 233, an air conditioning throttle value 234, a heating circulating pump 206, a fan coil air conditioner 207 and/or a radiator 208.

As shown in FIG. 22, in summer, the refrigeration part of the central air conditioning system is composed of the liquid air storage tank 45 and the liquid air storage tank 46. The liquid air 46 is fed by the liquid air storage tank liquid supply shut-off valve 48 through the liquid air storage tank liquid supply interface 49 through the air conditioning throttle value 234 into the liquid air heat exchanging device 231 to absorb the heat of the air conditioner hot and hot medium 233. The liquid air 46 is evaporated and evaporated into a gas with certain cold air, fully mixed with the air water through the gas-liquid mixture 232, and fully exchanges the remaining heat into the air conditioning cold and hot medium 233 of the air conditioner 23 to save the consumption of liquid air. The air finally released by the the air conditioning cold and hot water 233 and the released air is discharged to the air through the air discharge outlet 59 or into the room of the liquid air 46 to complete the ecological refrigeration energy saving cycle.

7° C. air conditioning cold and hot medium 233 is circulated by the hot water circulating pump 206, through the fan coil 207 and/or the air conditioning fan through the floor heating 208.

As shown in FIG. 22, in winter, for the heating part of the central air conditioning system, the molten salt 141 of the high temperature molten salt heat storage device 210 is heated by the electric heating device 145, and heated to about 600° C. for high temperature storage. And the molten salt 141 at 600° C. is circulated by the circulating pump 212 to heat the low temperature molten salt 141 in the low temperature molten salt heat storage tank 213, and heat it to about 400° C. and store it. The thermal conductive oil 129 in the the heat exchanging tank 225 is circulated into the low temperature molten salt heat exchanging device 227 by the low temperature molten salt heat exchanging pump and is heated to about 400° C. And the thermal conductive oil 129 is heated to below 90° C., and the heat exchanging pump 229 cycles the thermal conductive oil heat exchanging device 228 and is heated to 60° C.

The 60° C. air conditioner cold and heat water 233 is circulated by the heating circulating pump 206, and heated by the fan coil 207 and/or the floor heating 208.

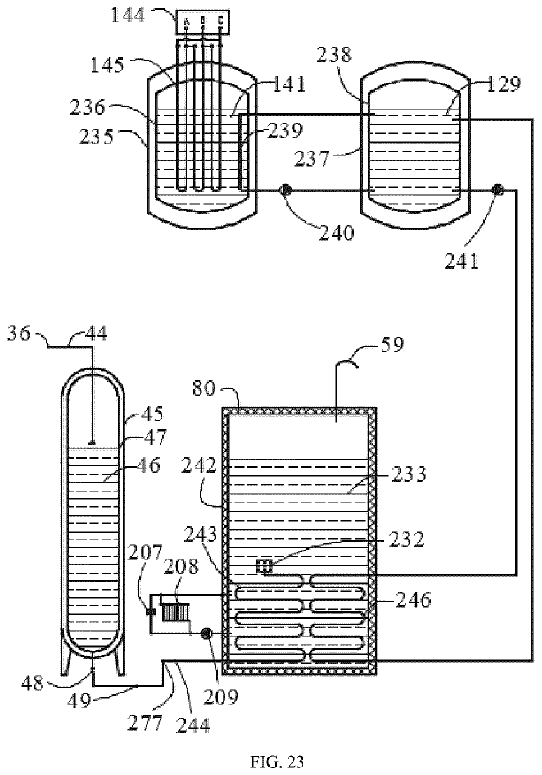

FIG. 23 is a schematic diagram of the liquid air refrigeration and molten salt heating central air conditioning system according to an embodiment of the present disclosure. As shown in FIG. 23, the liquid air refrigeration and molten salt heating central air conditioning system includes the empty storage tank 45, the liquid air 46, the heating and heating system includes molten salt heat storage tank 235, the molten salt heat storage tank 236, the molten salt 141, the electric heating device 145, a thermal conductive oil heat storage and heat exchanging tank 237, a thermal conductive oil heat storage and heat exchanging inner tank 238, the thermal conductive oil 129, a molten salt heat exchanging pump 240, a thermal conductive oil heat exchanging pump 241, an air conditioning cold and hot medium box 242, a refrigerant heat exchanging device 243, an air conditioning throttle value 244, air conditioning cold and hot medium 233, the air conditioning circulating pump 206, a fan coil air conditioner 207 and/or a floor heating 208.

In FIG. 23, only one molten salt heat storage tank 235 is configured for the heat storage, and one thermal conductive oil heat storage and heat exchanging tank 237 is used to reduce the temperature of the molten salt and increase the safe operation of the air conditioning cold and hot medium 233 is heated by the heat medium heat exchanging device 246 through the thermal conductive oil heat exchanging pump 241, and the others are basically the same as those in FIG. 22.

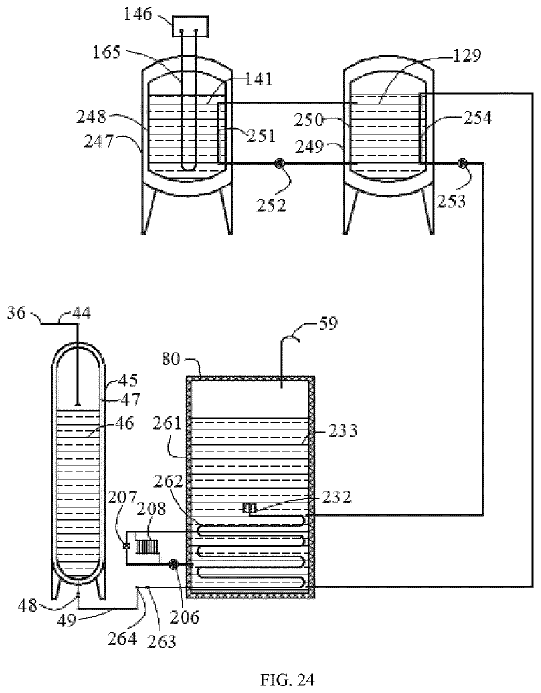

FIG. 24 is a schematic diagram of the liquid air refrigeration and molten salt heating domestic central air conditioning system according to an embodiment of the present disclosure. As shown in FIG. 24, the liquid air refrigeration and molten salt heating domestic central air conditioning system consists of the liquid air storage tank 45, the liquid air 46, and the heating. And heating system includes the molten salt heat storage tank 247, the thermal conductive oil heat storage and heat exchanging tank 248, the molten salt heat exchanging tank 141, the electric heating device 165, a thermal conductive oil heat storage and heat exchanging tank 249, a thermal conductive oil heat storage and heat exchanging inner tank 250, the heat conductive oil 129, a molten salt heat exchanging device 251, a molten salt heat exchanging pump 252, a thermal conductive oil heat exchanging pump 253, a thermal conductive oil output heat exchanging device 254, an air conditioning cold and hot medium tank 261, an air conditioning refrigerant heat exchanging device 262, an air conditioning throttle value 263 and the air conditioning cold and hot medium 233.

In winter, the molten salt heat storage tank 247 is suitable for domestic applications, using the single-phase power supply 146, the electric heating device 165 is immersed in the molten salt 141, and the liquid molten salt 141 is heated and obtain liquid molten salt 141. The molten salt heat exchanging pump 252 circulates the thermal conductive oil 129 and heated back to the conductive oil heat exchanging tank 249 by molten salt heat exchanging device 251, heating thermal conductive oil 129. thermal conductive oil 129 and the air conditioning cold and hot medium 233 circulated by the thermal conductive oil heat exchanging pump 253 through the thermal conductive oil output heat exchanging device 254.

In summer, the liquid air 46 enters the air conditioning refrigerant heat exchanging device 262 through the liquid air storage tank liquid supply shut-off valve 48, the liquid air storage tank liquid supply interface 49, the air conditioning throttle value 263, and absorbs the air conditioning cold and hot medium 233, and freeze it into 7° C. chilled water.

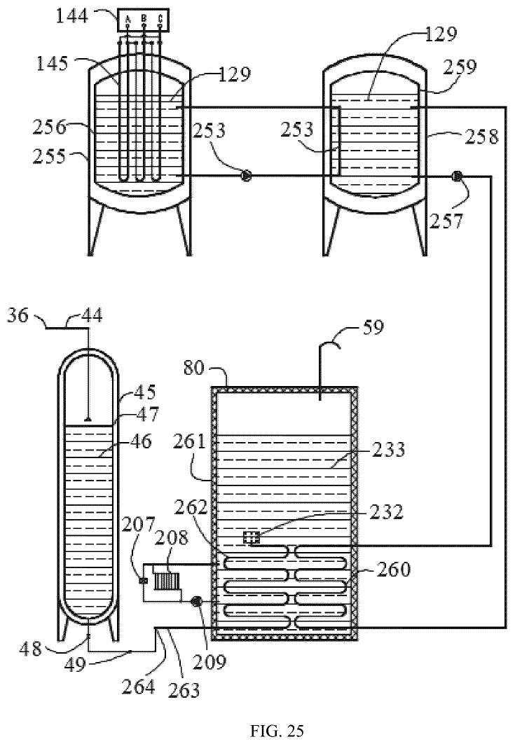

FIG. 25 is a schematic diagram of the liquid air refrigeration and power electric thermal conductive oil heat storage air conditioning system according to an embodiment of the present disclosure. As shown in FIG. 25, the liquid air refrigeration and power electric thermal conductive oil heat storage air conditioning system includes the liquid air storage tank 45, liquid air 46, and the thermal conductive oil heat storage tank 255, thermal conductive oil heat storage inner tank 256, the thermal conductive oil 129, the electric heating device 165, a thermal conductive oil heat exchanging device 201, thermal conductive oil heat exchanging pump 257, a thermal conductive oil heat storage and heat exchanging tank 258, a thermal conductive oil heat storage and heat exchanging tank 259, thermal conductive oil heat exchanging pump 253, the thermal conductive oil heat exchanging device 254, the air conditioning cold and hot medium tank 261, an air conditioning refrigerant heat exchanging device 262, an air conditioning throttle value 263, the air conditioning cold and hot medium 233, the air conditioning circulating pump 206, and the fan coil air conditioner 207 and/or the floor heating 208.

As shown in FIG. 25, the thermal conductive oil heat storage tank 255 is about 350° C., and the heat transfer temperature of the thermal conductive oil heat storage and heat exchanging tank 258 is about 200° C. The heating heat transfer process is basically the same as the above embodiment and is not repeated.

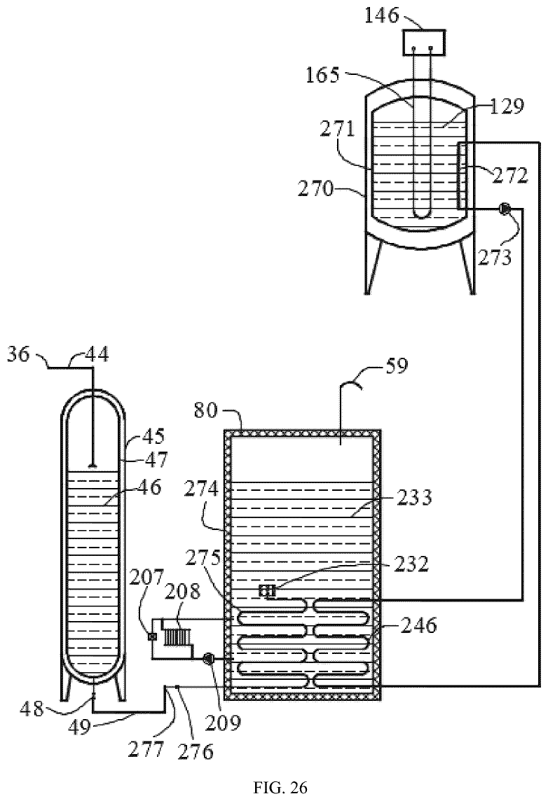

FIG. 26 is a schematic diagram of the liquid air refrigeration and single-phase thermal conductive oil heat storage domestic central air conditioning system according to an embodiment of the present disclosure. As shown in FIG. 26, the liquid air refrigeration and single-phase thermal conductive oil heat storage domestic central air conditioning system consists of the liquid air storage tank 45, the liquid air 46. And the heating system includes a thermal conductive oil heat storage tank 270, a thermal conductive oil heat storage exchanging inner tank 271, a thermal conductive oil heat exchanging device 272, a thermal conductive oil heat exchanging pump 273, an air conditioning cold and hot medium box 274, the cold and hot medium 233, the refrigerant water heat exchanging device 275, and an air conditioning throttle value 276.

As shown in FIG. 26, due to home application, although thermal conductive oil is not as good as molten salt for heat storage effect, in order to reduce the cost and safety and convenience, it is also a good choice to use thermal conductive oil for heat storage. The thermal conductive oil heat storage tank 270 is heated to about 350° C., and the working process is basically the same as that of FIG. 25.

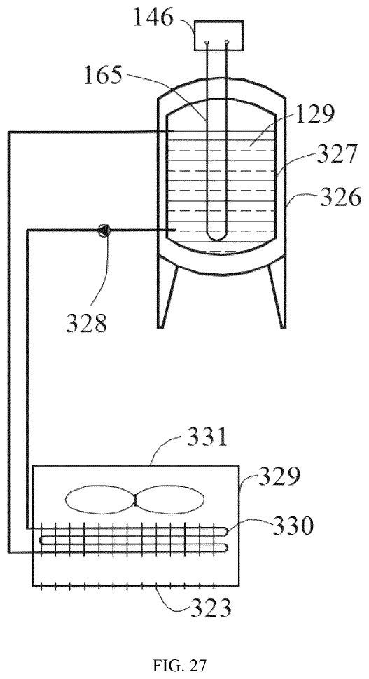

FIG. 27 is a schematic diagram of the thermal conductive oil energy storage heater according to an embodiment of the present disclosure. As shown in FIG. 27, the energy storage heater is composed of a thermal conductive oil heat storage tank 326, a thermal conductive oil circulating pump 328, a heater 329, an air heating heat exchanging device 330, a heater air inlet 331, a heater air outlet 332, and a fan 333.

The thermal conductive oil heat storage tank 326 provided with an electric heating device 165, and the electric heating device 165 is immersed in the thermal conductive oil 129 and heated by the thermal conductive oil 129. The heated thermal conductive oil enters the air heating heat exchanging device 330 through the heater 329, the air heating heat exchanging device 330, and the indoor air through the fan circulation, and the super cooled thermal conductive oil 129 is recycled to the conductive oil storage tank 326, repeating the above heating operation.

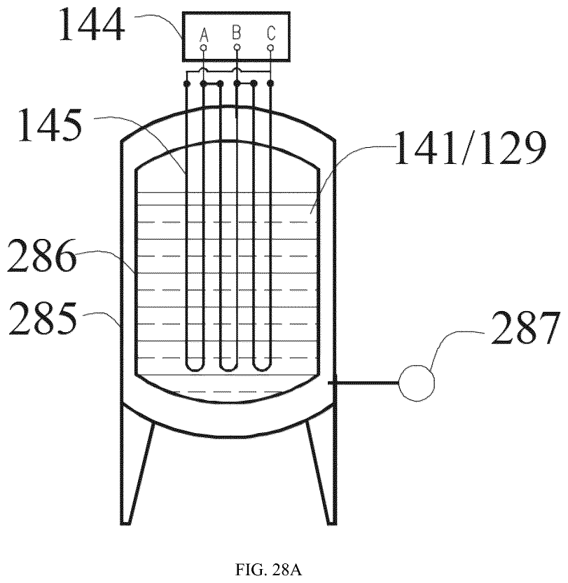

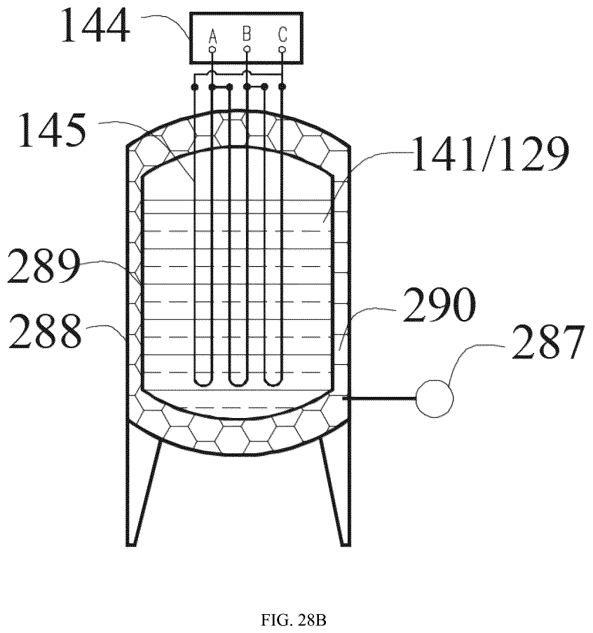

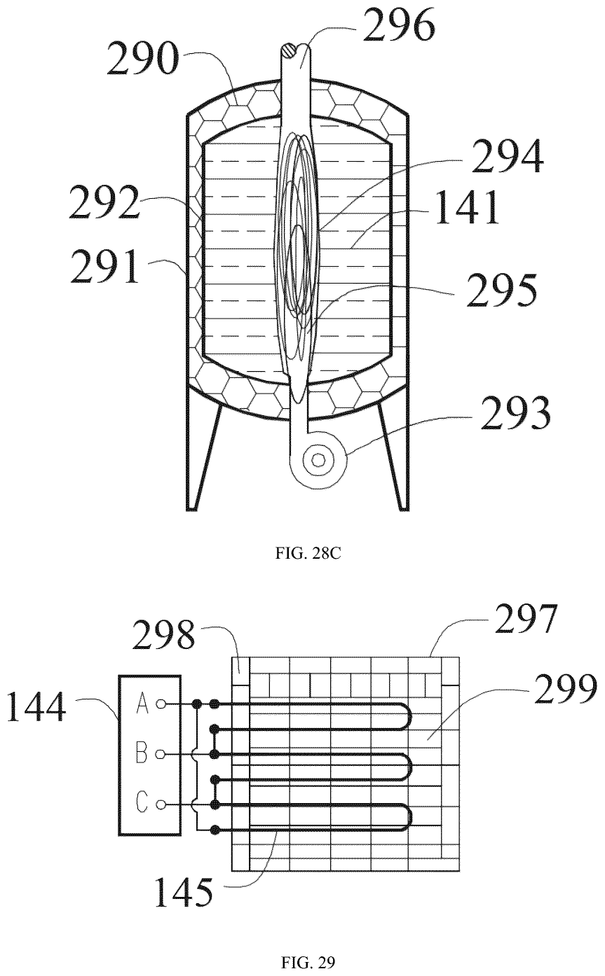

FIGS. 28A-28C are schematic diagram of the molten salt storage tank according to an embodiment of the present disclosure. As shown in FIG. 28A, the molten salt heat storage device 18 includes molten salt or thermal conductive oil heat storage outer tank 285, molten salt or thermal conductive oil heat storage inner tank 286, an outer/inner vacuum insulation gap 287, the molten salt 141 or the thermal conductive oil 129, and the electric heating device 145.

As shown in FIG. 28A, the outer/inner vacuum insulation gap 287 between the molten salt or thermal conductive oil heat storage outer tank 285 285 and molten salt or thermal conductive oil heat storage inner tank 286, and is configured for vacuum insulation. or

As shown in FIG. 28B, the molten salt heat storage device 18 includes the outer/inner vacuum insulation gap 288, the molten salt or thermal conductive oil heat storage inner tank 289, the outer/inner vacuum insulation gap 287, the high temperature insulation material 290, the molten salt 141 or thermal conductive oil 129, and the electric heating device 145.

The outer/inner vacuum insulation gap 288 of the molten salt or thermal conductive oil heat storage inner tank 289 forms the outer/inner vacuum insulation gap 287, and the high temperature insulation material 290 is added, using the vacuum state and the high temperature insulation material, and increasing the certain strength between the internal and external tanks.

As shown in FIG. 28C, the molten salt heat storage device 18 includes its molten salt heat storage tank 291, molten salt heat storage tank 292, high temperature insulation material 290, burner 293, flame heat radiation sheath 294, flame 295, chimney 296.

The gap between the molten salt heat storage outer tank 291, and the molten salt heat storage tank 202 is filled with the high temperature insulation material 290, the burner 293 is configured at the lower part of the molten salt heat storage tank 291, the flame 295 passes through the molten salt 141, and the flame 295 is burned in the flame heat radiation sheath 294, and the flame heat radiation sheath 294 is disposed between the flame 295 and the molten salt 141 to avoid the flame contacting the molten salt directly.

FIG. 29 is a schematic diagram of the solid heat storage device according to an embodiment of the present disclosure. As shown in FIG. 29, the molten salt heat storage includes a solid heat storage device 297, a fire-resistant insulation brick 298, and a solid heat storage material 299.

As shown in in FIG. 29, the solid heat storage material 299 is disposed in the fire- resistant insulation brick 298, and the electric heating 145 is arranged in the solid heat storage material 299 and is in contact with the solid heat storage material 299 to form a high temperature heat storage device.

Because the molten salt heat storage tank is limited by the maximum thermal temperature of the inner material, the molten salt heat storage can reach about 600° C. If the molten salt heat is stored in a high temperature of more than 600° C., it is not impossible, but the material structure of the inner is very expensive, and its cost performance is very low, the gain is not worth the loss. Therefore, fire-resistant insulation brick material is adopted, and the heat storage temperature of molten salt can be as high as about 1200° C. But it can not be stored to too high, because ordinary electric wire over 1400° C. will melt and evaporate.

Finally, it should be noted that the above embodiments are only used to illustrate the technical solutions of the present disclosure and are not limited thereto; although this disclosure is described in detail with reference to the foregoing embodiments, a person of ordinary skill in the art should understand that the technical solutions described in the foregoing embodiments may still be modified, or some or all of the technical features may be equivalently replaced; and these modifications or replacements do not make the essence of the corresponding technical solutions fall within the scope of the technical solutions of the embodiments of this disclosure.

1. An energy storage energy system, the energy storage energy system converts energy into a cold power and/or a heat power, and the cold power and/or the heat power being stored; the cold power being used as cold source of a freezing industry or an air conditioning refrigeration, and the heat power being used as heat source of a heating industry.

2. The energy storage energy system according to claim 1, wherein the energy storage energy system comprises energy sources (1) and the energy sources (1) comprises a cold storage (2) and/or a heat storage (3).

3. The energy storage energy system according to claim 2, wherein the energy sources (1) comprise an electric energy (4), and the electric energy (4) is generated by a wind power, a photovoltaic power generation, and a hydropower power generation, and a nuclear power, and a fossil fuel power generation, and a hydrogen energy generation, and an ammonia energy power generation and a public grid;
or
wherein a heat energy (5), the heat energy (5) is generated by a solar energy, a geothermal energy, and a renewable energy, and an industrial waste heat; and heat energy (5) is also generated by a fossil fuel, a hydrogen combustion, and an ammonia combustion, and a biomass combustion.

4. The energy storage energy system according to claim 1, wherein the cold storage (2) comprises a phase change cold storage (6), a sensible heat storage cold (7), or an absorption type cold storage (278);
or
wherein the heat storage (3) comprises a phase change heat storage (8) or a sensible heat storage heat (9).

5. The energy storage energy system according to claim 4, wherein the phase change cold storage (6) comprises a liquid air storage device (10), or a liquid nitrogen storage device (11), or a liquid carbon dioxide storage device (12), or a dry ice storage device (13), or an ice storage device (14);
or
wherein the sensible heat storage cold (7) comprises an oil cold storage device (15), or an organic/inorganic solution cold storage device (16), or an antifreezing fluid storage (17) or a water cold storage device (279);
or
wherein the absorption type cold storage (278) comprises a lithium bromide-water absorption/cold storage device (280), or an ammonia-water absorption/cold storage device (281).

6. The energy storage energy system according to claim 1, wherein the phase change heat storage (8) comprises a molten salt heat storage device (18), or a chemical material phase change heat storage device (19);
or
wherein the sensible heat storage heat (9) comprises an oil heat storage device (20), or a chemical solution heat storage device (21), or a water heat storage device (22).

7. The energy storage energy system according to claim 5, wherein the liquid air storage device (10) comprises an air compressor (23), a gas storage tank (26), and a heat exchanging device (29), and an expansion machine (51), and a liquid air storage tank (45);
wherein the heat exchanging device (29) comprises a heat exchanging device 30, a low temperature heat exchanging side (31), and a high temperature heat exchanging side (32), and a super low temperature heat exchanging side (33);
wherein an input end (24) of the air compressor (23) communicates with air; an output end (25) of the air compressor (23) is connected to an input end (27) of the gas storage tank (26); the gas storage tank (26) is output from a low temperature output end (28) and a high temperature output end (37); wherein the low temperature output end (28) is connected to an end (34) of the low temperature heat exchanging side (31); and another end (35) of the low temperature heat exchanging side (31) is connected to an input interface (36) of the liquid air storage tank (45), and is connected to the liquid air storage tank (45), and communicated with the liquid air (46); a high temperature output end (37) is connected to an end (38) of the high temperature heat exchanging side (32), another end (39) of the high temperature heat exchanging side (32) is connected to an input end (40) of the expansion machine (51); an output end (41) of the expansion machine (51) is connected to an end (42) of the super low temperature heat exchanging side (33), another end (43) of the super low temperature heat exchanging side (33) is connected to the input end (24) of the air compressor (23).

8. The energy storage energy system according to claim 7, wherein the liquid air storage device (10) comprises a liquid air storage tank (45) and a liquid air inner storage tank (47);
wherein a vacuum insulation layer is formed between the liquid air storage tank (45) and the liquid air inner storage tank (47), and the liquid air (46) is stored in the liquid air inner storage tank (47);
or
wherein the liquid air storage device (10) also comprises a motorized cold storage tank truck (50), the liquid air storage tank (45) and a pressurizer (52);
wherein the liquid air storage tank (45) is provided on the motorized cold storage tank truck (50).

9. The energy storage energy system according to claim 8, wherein the energy storage energy system comprises the liquid air storage tank (45), liquid air (46), and a coil liquid air throttle value (88), and/or a air cooler liquid air throttle value (57), and/or an air cooler (64), and/or a freezing coil (65);
wherein an end of the air cooler (64) and/or the freezing coil (65) is connected to the liquid air storage tank (45) by the air cooler liquid air throttle value (57) and/or the coil liquid air throttle value (88) and communicated with the liquid air (46); another end of the air cooler (64) and/or the freezing coil (65) is connected to the air discharge outlet (59) and communicated with the air.

10. The energy storage energy system according to claim 9, wherein the energy storage energy system comprises the liquid air storage tank (45), the liquid air (46), and a liquid air freezing cold storage device (55), and a freezing coil heat exchanging device (56), and a freezing medium (58), and a freezing coil throttle value (62), and a freezing medium circulating pump (63), and an air cooler (64) and/or a freezing coil (65);
wherein the liquid air freezing cold storage device (55) is equipped with a freezing medium (58), the freezing coil heat exchanging device (56) is immersed in the freezing medium (58); an end of the freezing coil heat exchanging device (56) is connected with the liquid air storage tank (45) through the freezing coil throttle value (62) and communicated with the liquid air (46); and another end of the freezing coil heat exchanging device (56) is connected with the air discharge outlet (59) and communicated with air;
wherein an end of the freezing medium circulating pump (63) is connected to the liquid air freezing cold storage device (55) and communicated with the freezing medium (58); another end of the freezing medium circulating pump (63) is connected to the liquid air freezing cold storage device (55) through the air cooler (64) and/or the freezing coil (65) and communicated with the freezing medium (58).

11. The energy storage energy system according to claim 10, wherein the energy storage energy system comprises the liquid air storage tank (45), the liquid air (46), a low temperature liquid air cold storage device (66), a low temperature freezing coil heat exchanging device (67), a low temperature freezing medium (69), a low temperature coil throttle value (70), a high temperature coil throttle value (71), a high temperature liquid air cold storage device (72), a high temperature freezing coil heat exchanging device (73), a gas-liquid mixer (74) and a high temperature freezing medium (75);
wherein the low temperature freezing medium (69) is provided in the low temperature liquid air cold storage device (66); the low temperature freezing coil heat exchanging device (67) is immersed in the low temperature freezing medium (69), an end of the low temperature freezing coil heat exchanging device (67) is connected to the liquid air storage tank (45) through the low temperature coil throttle value (70) and communicated with the liquid air (46); and another end of the low temperature freezing coil heat exchanging device (67) is connected with an end of a high temperature freezing coil heat exchanging device (73) of the high temperature liquid air cold storage device (72) through the high temperature coil throttle value (71);
wherein an end of the freezing medium circulating pump (63) is connected with the low temperature liquid air cold storage device (66) and communicated with the low temperature freezing medium (69); and another end of the freezing medium circulating pump (63) is connected with the low temperature liquid air cold storage device (66) through the air cooler (64) and/or the freezing coil (65), and communicated with the low temperature freezing medium (69);
wherein the high temperature liquid air cold storage device (72) is equipped with a high temperature freezing medium (75); the high temperature freezing coil heat exchanging device (73) is immersed in the high temperature freezing medium (75); an end of the high temperature freezing coil heat exchanging device (73) is connected to the low temperature freezing coil heat exchanging device (67) through the high temperature coil throttle value (71); and another end of the high temperature freezing coil heat exchanging device (73) is connected to the gas-liquid mixer (74), and communicated with the high temperature freezing medium (75);
wherein an end of the freezing medium circulating pump (63) is connected to the high temperature liquid air cold storage device (72), and communicated with the high temperature freezing medium (75); and another end of the freezing medium circulating pump (63) is connected to the high temperature liquid air cold storage device (72) through the air cooler (64) and/or the freezing coil (65), and communicated with the high temperature freezing medium (75).

12. The energy storage energy system according to claim 11, wherein the energy storage energy system comprises the liquid air storage tank (45), the liquid air (46), and a super low temperature liquid air cold storage device (76), and a super low temperature freezing coil heat exchanging device (77), and a super low temperature freezing medium (79), and a super low temperature throttle value (90), and a low temperature liquid air cold storage device (81), and a low temperature freezing coil heat exchanging device (82), and a low temperature freezing medium (84), and a low temperature throttle value (80), and a high temperature liquid air cold storage device (86), and a high temperature freezing coil heat exchanging device (87), and a high temperature freezing medium (89), and a high temperature throttle value (85), and the gas-liquid mixer (74);
wherein the super low temperature liquid air cold storage device (76) is equipped with the super low temperature freezing medium (79), the super low temperature freezing coil heat exchanging device (77) is immersed in the super low temperature freezing medium (79) with an end connected to the liquid air storage tank (45) through the super low temperature throttle value (90) and communicated with the liquid air (46);
wherein an end of the freezing medium circulating pump (63) is connected to the super low temperature liquid air cold storage device (76), and communicated with the super low temperature freezing medium (79);
wherein the low temperature liquid air cold storage device (81) is equipped with the low temperature freezing medium (84), the low temperature freezing coil heat exchanging device (82) is immersed in the low temperature freezing medium (84); an end of the low temperature freezing coil heat exchanging device (82) is connected to the super low temperature freezing coil heat exchanging device (77) through the low temperature throttle value (80), another end is connected to the high temperature freezing coil heat exchanging device (87) through the high temperature throttle value (85);
wherein an end of the freezing medium circulating pump (63) is connected to the low temperature liquid air cold storage device (81) and communicated with the freezing medium (84); and another end is connected with the low temperature liquid air cold storage device (81) through the air cooler (64) and/or the freezing coil (65) and communicated with the freezing medium (84);
wherein the high temperature liquid air cold storage device (86) is provided with the high temperature freezing medium (89);
wherein the high temperature freezing coil heat exchanging device (87) is immersed in the high temperature freezing medium (89); an end of the high temperature freezing coil heat exchanging device (87) is connected to the low temperature freezing coil heat exchanging device (82) through a high temperature throttle value (85); and another end of the high temperature freezing coil heat exchanging device (87) is connected to the gas-liquid mixer (88);
wherein an end of the freezing medium circulating pump (63) is connected to the high temperature liquid air cold storage device (86), and communicated with the high temperature freezing medium (89); and another end is connected to the high temperature liquid air cold storage device (86) through the air cooler (64) and/or the freezing coil (65), and communicated with the high temperature freezing medium (89).

13. The energy storage energy system according to claim 12, wherein the energy storage energy system is a liquid air freezer of a refrigerator, comprises the liquid air storage tank (45), the liquid air (46), and a refrigerator freezer throttle value (92), and a liquid air freezer (93), and a refrigeration box (94), and a freezing coil (95), and a fresh- keeping box (96), and a high temperature coil (97) and a freezer air outlet (98);
wherein the refrigeration box (94) is provided with the freezing coil (95) or the air cooler (64); an end of the freezing coil (95) is connected with the liquid air storage tank (45) through a freezer solenoid valve (91), and communicated with the liquid air (46);
wherein the fresh-keeping box (96) is provided with the high temperature coil (97) or the air cooler (64); and an end of the high temperature coil (97) is connected with the freezing coil (95); and another end is connected with the freezer air outlet (98) and communicated with the air.

14. The energy storage energy system according to claim 13, wherein the energy storage energy system comprises the liquid air storage tank (45), the liquid air (46), and a ultra-low temperature liquid air freezing device (99), and a ultra-low temperature freezing throttle value (101) and/or a ultra-low temperature coil throttle value (109), and a liquid air spray nozzle (102) and/or a ultra-low temperature freezing coil (103), and a super low temperature liquid air freezing device (105), and a super low temperature freezing throttle value (104), and a low temperature liquid air freezing device (106), and an air cooler (107), and a low temperature liquid air releasing device (108);
wherein the ultra-low temperature liquid air freezing device (99) is equipped with a liquid air spray nozzle (102) and/or a ultra-low temperature freezing coil (103); an end of the liquid air spray nozzle (102) and/or the ultra-low temperature freezing coil (103) is connected to the liquid air storage tank (45) through the ultra-low temperature freezing throttle value (101) and/or a ultra-low temperature coil throttle value (109), and communicated with the liquid air (46); and another end of the liquid air spray nozzle (102) and/or the ultra-low temperature freezing coil (103) is communicated with the ultra-low temperature liquid air freezing device (99); and/or another end of the ultra-low temperature freezing coil (103) is connected to the super low temperature throttle value (104);
wherein the super low temperature liquid air freezing device (105) is provided with the air cooler (107); an end of the air cooler (107) is connected to the super low temperature freezing throttle value (104); and another end of the air cooler (107) is connected to the low temperature liquid air releasing device (108) which is inside the low temperature liquid air freezing device (106); and the liquid air releasing device (108) is communicated with the low temperature liquid air freezing device (106);
wherein the low temperature liquid air freezing device (106) comprises the low temperature liquid air releasing device (108) which is provided in the low temperature liquid air freezing device (106), and communicated with the low temperature liquid air freezing device (106); the low temperature liquid air releasing device (108) is located inside the low temperature liquid air freezing device (106), an end of the low temperature liquid air releasing device (108) is connected with the air cooler (107) and another end is communicated with the low temperature liquid air freezing device (106).

15. The energy storage energy system according to claim 10, wherein the energy storage energy system comprises the liquid air storage tank (45), the liquid air (46), the liquid air air conditioning cold storage device (111), the air conditioning coil heat exchanging device (112), chilled water (114), an air conditioning throttle value (115), an air conditioning circulating pump (117) and a fan coil air conditioner (118);
wherein the air conditioning coil heat exchanging device (112) is immersed in chilled water (114); an end of the air conditioning coil heat exchanging device (112) is connected with an end of the air conditioning throttle value (115); and another end of the air conditioning throttle value (115) is connected with the liquid air storage tank (45) and communicated with the liquid air (46); and another end of the air conditioning coil heat exchanging device (112) is connected with the gas-liquid mixer (113) and communicated with the chilled water (114);
wherein an end of the air conditioning circulating pump (117) is connected to the liquid air air conditioning cold storage device (111) and communicated with the chilled water (114); another end of the air conditioning circulating pump (117) is connected to an end of the fan coil air conditioner (118); and another end of the fan coil air conditioner (118) is connected to the liquid air air conditioning cold storage device (111) and communicated with the chilled water (114).

16. The energy storage energy system according to claim 15, wherein the energy storage energy system comprises the liquid air storage tank (45), the liquid air (46), and a low temperature air conditioning cold storage device (119), and the low temperature air conditioning coil heat exchanging device (120), and the low temperature chilled water (122), and the low temperature air conditioning throttle value (123), and an air conditioning throttle value (125), and an air conditioning cold storage device (126), and an air conditioning coil heat exchanging device (127), and a gas-liquid mixer (113), and the chilled water (114), and the air conditioning circulating pump (117), and the fan coil air conditioner (118);
wherein the low temperature air conditioning coil heat exchanging device (120) is immersed in the low temperature chilled water (122), the air conditioning coil heat exchanging device (127) is immersed in the chilled water (114); and an end of the low temperature air conditioning coil heat exchanging device (120) is connected to an end of the low temperature air conditioning throttle value (123), another end of the low temperature air conditioning throttle value (123) is connected to the liquid air storage tank (45) and communicated with the liquid air (46); another end of the low temperature air conditioning coil heat exchanging device (120) is connected to an end of the air conditioning coil heat exchanging device (127) through the air conditioning throttle value (125); another end of the air conditioning coil heat exchanging device (127) is connected to the gas-liquid mixer (113), and communicated with the chilled water (114);
wherein an end of the air conditioning circulating pump (117) is connected to the low temperature air conditioning cold storage device (119) and communicated with the low temperature chilled water (122); another end of the air conditioning circulating pump (117) is connected to an end of the fan coil air conditioner (118); and another end of the fan coil air conditioner (118) is connected to the low temperature air conditioning cold storage device (119) and communicated with the low temperature chilled water (122);
wherein an end of the air conditioning circulating pump (117) is connected to the air conditioning cold storage device (126) and communicated with the chilled water (114); an end of the air conditioning circulating pump (117) is connected to an end of the fan coil air conditioner (118); and another end of the fan coil air conditioner (118) is connected to the air conditioning cold storage device (126) and communicated with the chilled water (114).

17. The energy storage energy system according to claim 16, wherein the energy storage energy system comprises the liquid air storage tank (45), the liquid air (46), and a liquid air split air conditioner (130);
wherein the liquid air split air conditioner (130) comprises a coil surface air cooler (131) and a fan (133);
wherein an end of the coil surface air cooler (131) is connected with the liquid air storage tank (45) through the air conditioning throttle value (137) and communicated with the liquid air (46); and another end of the coil surface air cooler (131) is connected with the air releasing port (136) and communicated with the air;
or
wherein the liquid air split air conditioner (130) comprises the coil surface air cooler (131), the fan (133), a split air conditioning thermal conductive oil storage tank (323), an electric heating device (165), thermal conductive oil (129), an air heater (283), a split air conditioning heating pump (268);
wherein the air heater (283) is located between the coil surface air cooler (131) and the fan (133); an end of the air heater (283) is connected to the split air conditioning thermal conductive oil storage tank (323) through the split air conditioning heating pump (268) and communicated with the thermal conductive oil (129); and another end of the air heater (283) is connected with the split air conditioning thermal conductive oil storage tank (323) and communicated with the thermal conductive oil (129).

18. The energy storage energy system according to claim 6, wherein the molten salt heat storage device (18) comprises a molten salt heat storage tank (139), a molten salt (141), and the electric heating device (145), and a molten salt output interface (142), and a molten salt input interface (143);
wherein the molten salt (141) is located in the molten salt heat storage tank (139); the electric heating device (145) is immersed in the molten salt (141); and the molten salt output interface (142) is connected to the molten salt heat storage tank (139) and communicated with the molten salt (141); and the molten salt input interface (143) is connected to the molten salt heat storage tank (139) and communicated with the molten salt (141);
or
wherein the molten salt heat storage device (18) comprises a molten salt heat storage tank (147), the molten salt (141), and the electric heating device (145), and a molten salt coil heat exchanging device (151);
wherein the molten salt (141) is located in the molten salt heat storage tank (147); the electric heating device (145) is immersed in the molten salt (141); and the molten salt coil heat exchanging device (151) is immersed in the molten salt (141);
or
wherein the molten salt heat storage device (18) comprises molten salt heat storage tank (158), the molten salt (141), and the electric heating device (145), and a molten salt heat exchanging device (160);
wherein the molten salt (141) is located in the molten salt heat storage tank (158); the electric heating device (145) is immersed in the molten salt (141); and the molten salt heat exchanging device (160) is immersed in the molten salt (141);
or
wherein the molten salt heat storage device (18) comprises the molten salt heat storage tank (154), the molten salt (141), and an electric heating device (165), and the molten salt output interface (156), and the molten salt input interface (157);
wherein the molten salt (141) is provided in the molten salt heat storage tank (154), the electric heating device (145) is immersed in the molten salt (141); and the molten salt heat storage tank (154) is provided with the molten salt output interface (156) and communicated with the molten salt (141); and the molten salt heat storage tank (154) is provided with the molten salt input interface (157) and communicated with the molten salt (141);
or
wherein the molten salt heat storage device (18) comprises a single-phase power supply molten salt heat storage tank (325), the molten salt (141), and the electric heating device (165), and a molten salt input interface (301), and a molten salt output interface (302), and a molten salt heat exchanging device (303), and a molten salt heat exchanging device input interface (304), and a molten salt heat exchanging device output interface (305);
wherein the molten salt (141) is provided in the single-phase power supply molten salt heat storage tank (325); the electric heating device (165) is immersed in the molten salt (141); and the single-phase power supply molten salt heat storage tank (325) is provided with the molten salt input interface (301) and communicated with the molten salt (141); and the single-phase power supply molten salt heat storage tank (325) is provided with the molten salt output interface (302) and communicated with the molten salt (141); and the molten salt heat exchanging device (303) is immersed in the molten salt (141);
or
wherein the molten salt heat storage device (18) comprises a molten salt heat storage tank (319), the molten salt (141), and the electric heating device (165), and the molten salt heat exchanging device (321);
wherein the molten salt (141) is located in the molten salt heat storage tank (319), the electric heating device (165) is immersed in the molten salt (141); the molten salt heat tank (319) is provided with the molten salt heat exchanging device (321) and immersed in the molten salt (141).

19. The energy storage energy system according to claim 6, wherein the oil heat storage device (20) comprises an oil heat storage tank (163), a low temperature oil heat exchanging device (166) and/or a high temperature oil heat exchanging device (169), the thermal conductive oil (129), and an electric heating device (145);
wherein the thermal conductive oil (129) is located in the oil heat storage tank (163); the electric heating device (145) is immersed in the thermal conductive oil (129); and the low temperature oil heat exchanging device (166) and/or the high temperature oil heat exchanging device (169) are/is immersed in the thermal conductive oil (129);
or
wherein the oil heat storage device (20) comprises an oil heat storage tank (180), an oil heat exchanging device (182), and the thermal conductive oil (129), and an electric heating device (165);
wherein the oil heat storage tank (180) is provided with the oil heat exchanging device (182) and immersed in the thermal conductive oil (129); the electric heating device (165) is immersed in the thermal conductive oil (129);
or
wherein the oil heat storage device (20) comprises the oil heat storage tank (185), a low temperature oil heat exchanging device (187) and/or a high temperature oil heat exchanging device (190), and the thermal conductive oil (129), and an electric heating device (165);
wherein the oil heat storage tank (185) is provided with the low temperature oil heat exchanging device (187) and/or the high temperature oil heat exchanging device (190), and is immersed in the thermal conductive oil (129); and the electric heating device (165) is immersed in the thermal conductive oil (129);
or
wherein the oil heat storage device (20) comprises an oil heat storage and heat exchanging tank (172), a low temperature oil heat exchanging device (174) and/or a high temperature oil heat exchanging device (177), and the thermal conductive oil (129);
wherein the oil heat storage and heat exchanging tank (172) is provided with the low temperature oil heat exchanging device (174) and/or the high temperature oil heat exchanging device (177) and immersed in the thermal conductive oil (129).

20. The energy storage energy system according to claim 18, wherein the molten salt heat storage device (18) comprises a molten salt heat storage tank (306), a high temperature molten salt testing tank (308), and a high temperature tank heat exchanging device (309), and a high temperature tank (310), and a molten salt pump (311), and the molten salt (141), and the electric heating device (145);
wherein the high temperature tank heat exchanging device (309) is located in the high temperature molten salt testing tank (308), an end of which is connected to the molten salt heat storage tank (306) through the molten salt pump (311) and communicated with the molten salt (141); another end of the high temperature tank heat exchanging device (309) is connected to the molten salt heat storage tank (306) and communicated with the molten salt (141);
or
wherein the molten salt heat storage device (18) comprises a molten salt heat storage tank (312), the molten salt (141), and the electric heating device (145), and the molten salt heat exchanging device (314), and the molten salt heat exchanging pump (315), and thermal conductive oil heat storage exchanging tank (316), and a thermal conductive oil heat exchanging pump (318), and a high temperature molten salt testing tank (308), and a high temperature tank heat exchanging device (309), and the thermal conductive oil (129);
wherein the molten salt heat storage tank (312) is provided with the molten salt heat exchanging device (314); an end of the molten salt heat exchanging device (314) is connected to the thermal conductive oil heat storage exchanging tank (316) and communicated with the thermal conductive oil (129); another end of the molten salt heat exchanging device (314) is connected to the thermal conductive oil heat storage exchanging tank (316) and communicated with the thermal conductive oil (129);
wherein an end of the thermal conductive oil heat exchanging pump (318) is connected to an end of the thermal conductive oil heat storage exchanging tank (316) and communicated with the thermal conductive oil (129); another end of the thermal conductive oil heat exchanging pump (318) is connected to an end of the high temperature tank heat exchanging device (309); and another end of the high temperature tank heat exchanging device (309) is connected to the thermal conductive oil heat storage exchanging tank (316) and communicated with the thermal conductive oil (129).

21. The energy storage energy system according to claim 20, wherein the molten salt heat storage device (18) comprises a molten salt heat storage tank (193), the molten salt (141), and the electric heating device (145), and a thermal conductive oil heat exchanging tank (198), and the thermal conductive oil (129), and a molten salt heat exchanging pump (197), and a molten salt heat exchanging device (200), and a thermal conductive oil heat exchanging device (201), and a thermal conductive oil heat exchanging pump (202), and a hot water storage tank (203), and hot water and/or domestic hot water (204), and a hot water circulating pump (206), and a fan coil air conditioner (207) and/or a floor heating (208) and/or a bath shower (209);
wherein the molten salt (141) is provided in the molten salt heat storage tank (193), the molten salt heat storage tank (193) is provided with the electric heating device (145) and is immersed in the molten salt (141); the molten salt heat storage tank (193) is provided with the molten salt heat exchanging device (200) and is immersed in the molten salt (141); and an end of the molten salt heat exchanging device (200) is connected to the thermal conductive oil heat exchanging tank (198) through an end of the molten salt heat exchanging pump (197) and communicated with the thermal conduction oil (129); and another end of the molten salt heat exchanging device (200) is connected to the thermal conductive oil heat exchanging tank (198) and communicated with the thermal conductive oil (129);
wherein the thermal conductive oil exchanging tank (198) is provided with the thermal conductive oil heat exchanging device (201) and is immersed in the thermal conductive oil (129); an end of the thermal conductive oil heat exchanging device (201) is connected with the hot water storage tank (203) through the thermal conductive oil heat exchanging pump (202) and communicated with the heating water or domestic hot water (204); and another end of the thermal conductive oil heat exchanging device (201) is connected with the hot water storage tank (203) and communicated with the hot water or domestic hot water (204);
wherein an end of the hot water circulating pump (206) is connected with the hot water storage tank (203) and communicated with the hot water or domestic hot water (204); another end of the hot water circulating pump (206) is connected with an end of the fan coil (207) and/or the heating floor (208) and/or the bath shower (209); another end of the fan coil air conditioner (207) and/or the heating floor (208) and/or the bath shower (209) is connected with the hot water storage tank (203) and communicated with the hot water or domestic hot water (204).

22. The energy storage energy system according to claim 21, wherein the molten salt heat storage device (18) comprises the high temperature molten salt heat storage tank (195), the molten salt (141), and a molten salt circulating pump (212), and the electric heating device (145), and a low temperature molten salt heat storage tank (213), and a low temperature molten salt heat exchanging device (216), and a water pump (218), and a water interface (219), and a steam storage tank (220), and steam (221), and steam output interface (223);
wherein an end of the molten salt pump (212) is connected with the high temperature molten salt heat storage (195) and communicated with the molten salt (141); another end is connected to the low temperature molten salt heat storage tank (213) and communicated with the molten salt (141); and the high temperature molten salt heat storage tank (195) is connected to the low temperature molten salt heat storage tank (213) and communicated with the molten salt (141);
wherein an end of the low temperature molten salt heat exchanging device (216) is connected to a water interface (219) through a water pump (218); another end of the low temperature molten salt heat exchanging device (216) is connected to a steam storage tank (220) and communicated with the steam (221); and the steam (221) is communicated with the steam output interface (223).

23. The energy storage energy system according to claim 22, wherein the energy storage energy system comprises the liquid air storage tank (45), the liquid air (46), and the high temperature molten salt heat storage tank (210), and the molten salt (141), and the high temperature molten salt circulating pump (212), and the electric heating device (145), and the low temperature molten salt heat storage tank (213), and a low temperature molten salt heat exchanging pump (224), and a thermal conductive oil heat storage and heat exchanging tank (225), and a low temperature molten salt heat exchanging device (227), and a thermal conductive oil heat exchanging device (228), and a thermal conductive oil heat exchanging pump (229), and an air conditioning medium storage box (230), and the liquid air heat exchanging device (231), and the gas- liquid mixer (232), and the air conditioning cold and hot medium (233), and the air conditioning throttle value (234);
wherein the air conditioning medium storage box (230) is provided with the air conditioning cold and hot medium (233); and the liquid air heat exchanging device (231) is immersed in the air conditioning cold and hot medium (233); an end of the liquid air heat exchanging device (231) is connected to the liquid air storage tank (45) and communicated with the liquid air (46); and another end of the liquid air heat exchanging device (231) is connected with the gas-liquid mixer (232), and the gas-liquid mixer (232) is immersed in the air conditioning cold and hot medium (233) and communicated with the air conditioning cold and hot medium (233);
wherein the high temperature molten salt storage tank (210) is provided with the molten salt (141) and the electric heating device (145); an end of the molten salt circulating pump (212) is connected to the high temperature molten salt heat storage tank (210) and communicated with the molten salt (141); and another end of the molten salt circulating pump (212) is connected with the low temperature molten salt heat storage tank (213) and communicated with the molten salt (141);the high temperature molten salt heat storage tank (210) is connected to the low temperature molten salt heat storage tank (213) and communicated with the molten salt (141);
wherein the low temperature molten salt heat exchanging device (227) is immersed in the low temperature molten salt heat storage tank (213); an end of the low temperature molten salt heat exchanging device (227) is connected to the thermal conductive oil heat storage and heat exchanging tank (225) through the low temperature molten salt heat exchanging pump (224) and communicated with the thermal conductive oil (129); and another end of the low temperature molten salt heat exchanging device (227) is connected to the thermal conductive oil heat storage and heat exchanging tank (225) and communicated with the thermal conductive oil (129);
wherein an end of the thermal conductive oil heat exchanging device (228) is connected with the air conditioning medium storage box (230) through the thermal conductive oil heat exchanging pump (229) and communicated with the cold and hot medium (233); and another end of the thermal conductive oil heat exchanging device (228) is connected with the air conditioning medium storage box (230) and communicated with the cold and hot medium (233);
wherein an end of the air conditioning circulating pump (206) is connected to the air conditioning medium storage box (230) and communicated with the cold and hot medium (233); another end of the air conditioning circulating pump (206) is connected with an end of the fan coil air conditioner (207) and/or the heating floor (208); and another end of the fan coil air conditioner (207) and/or the heating floor (208) is connected to the air conditioning medium storage box (230) and communicated with the cold and hot medium (233).

24. The energy storage energy system according to claim 23, wherein the energy storage energy system comprises the liquid air storage tank (45), the liquid air (46), and a molten salt heat storage tank (235), and the molten salt (141), and the electric heating device (145), and a thermal conductive oil heat storage and heat exchanging tank (237), and the thermal conductive oil (129), and a molten salt heat exchanging device (239), and a molten salt heat exchanging pump (240), and a thermal conductive oil exchanging pump (241), and an air conditioning cold and hot medium box (242), and a refrigerant heat exchanging device (243), and a liquid air throttle value (244), and a heat medium heat exchanging device (246), and the cold and hot medium (233), and the air conditioning circulating pump (206), and the fan coil air conditioner (207) and/or the floor heating (208);
wherein an end of the refrigerant heat exchanging device (243) is connected to the liquid air storage tank (45) through the liquid air throttle value (244) and communicated with the liquid air (46); and another end of the refrigerant heat exchanging device (243) is connected to the gas-liquid mixer (232) and communicated with the cold and hot medium (233);
wherein an end of the molten salt heat exchanging pump (240) is connected to an end of the thermal conductive oil heat storage and heat exchanging tank (237) and communicated with the thermal conductive oil (129); another end of the molten salt heat exchanging pump (240) is connected to an end of the molten salt heat exchanging device (239); and another end of the molten salt heat exchanging device (239) is connected to the thermal conductive oil heat storage and heat exchanging tank (237) and communicated with the thermal conductive oil (129);
wherein an end of the thermal conductive oil heat exchanging pump (241) is connected to an end of the thermal conductive oil heat storage and heat exchanging tank (237) and communicated with the thermal conductive oil (129); another end of the thermal conductive oil heat exchanging pump (241) is connected to an end of the heat medium heat exchanging device (246); and another end of the heat medium heat exchanging device (246) is connected to the thermal conductive oil heat storage and heat exchanging tank (237) and communicated with the thermal conductive oil (129);
wherein an end of the air conditioning circulating pump (206) is connected to the air conditioning medium storage box (242) and communicated with the cold and hot medium (233); another end of the air conditioning circulating pump (206) is connected to an end of the fan coil air conditioner (207) and/or the heating floor (208); and another end of the fan and coil air conditioner (207) and/or the heating floor (208) is connected to the air conditioning medium storage box (242) and communicated with the cold and hot medium (233).

25. The energy storage energy system according to claim 24, wherein the energy storage energy system comprises the liquid air storage tank (45), the liquid air (46), and the molten salt heat storage tank (247), and the molten salt (141), and the electric heating device (165), and the thermal conductive oil heat storage and heat exchanging tank (249), and the thermal conductive oil (129), and a molten salt heat exchanging device (251), and a molten salt heat exchanging pump (252), and a thermal conductive oil heat exchanging pump (253), and an air conditioning cold and hot medium tank (261), and a refrigerant heat exchanging device (262), the thermal conductive oil output heat exchanging device (254), and the air conditioning throttle value (263), and the cold and hot medium (233);
wherein an end of the refrigerant heat exchanging device (262) is connected to the liquid air storage tank (45) through the air conditioning throttle value (263) and communicated with the liquid air (46); and another end of the refrigerant heat exchanging device (262) is connected to the gas-liquid mixer (232) and communicated with the cold and hot medium (233);
wherein an end of the molten salt heat exchanging device (251) is connected to the thermal conductive oil heat storage and heat exchanging tank (249) through the molten salt heat exchanging pump (252) and communicated with the thermal conductive oil (129); another end of the molten salt heat exchanging device (251) is connected with the thermal conductive oil heat storage and heat exchanging tank (249) and communicated with the thermal conductive oil (129);
wherein an end of the thermal conductive oil output heat exchanging device (254) is connected with the air conditioning cold and hot medium tank (261) through the thermal conductive oil heat exchanging pump (253) and communicated with the cold and hot medium (233), and another end of the thermal conductive oil output heat exchanging device (254) is connected with the air conditioning cold and hot medium tank (261) and communicated with the cold and hot medium (233);
wherein an end of the air conditioning circulating pump (206) is connected to the air conditioning cold and hot medium tank (261) and communicated with the cold and hot medium (233); another end of the air conditioning circulating pump (206) is connected to an end of the fan coil air conditioner (207) and/or the heating floor (208); and another end of the fan coil air conditioner (207) and/or heating floor (208) is connected to the air conditioning cold and hot medium tank (261) and communicated with the cold and hot medium (233).

26. The energy storage energy system according to claim 25, wherein the energy storage energy system comprises the liquid air storage tank (45), the liquid air (46), and the thermal conductive oil heat storage tank (255), and the thermal conductive oil heat exchanging pump (253), and the thermal conductive oil (129), and the electric heating device (145), and the thermal conductive oil heat exchanging device (254), and the thermal conductive oil heat exchanging pump (257), and the thermal conductive oil heat storage and heat exchanging tank (258), and the heat medium water heating coil (260), and the air conditioning cold and hot medium tank (261), and the air conditioning refrigerant coil (262), and the air conditioning throttle value (263), and the cold and hot medium (233), and the air conditioning circulating pump (206), and the fan coil air conditioner (207) and/or the floor heating (208);
wherein an end of the air conditioning refrigerant coil (262) is connected to the liquid air storage tank (45) through an air conditioning throttle value (264) and communicated with the liquid air (46); and another end of the air conditioning refrigerant coil (262) is connected to the gas-liquid mixer (232) and communicated with the cold and hot medium (233);
wherein the thermal conductive oil heat exchanging device (254) is connected to the thermal conductive oil heat storage tank (255) through the thermal conductive oil heat exchanging pump (253) and communicated with the thermal conductive oil (129); and another end of the thermal conductive oil heat exchanging device (254) is connected to the thermal conductive oil heat storage tank (255) and communicated with the thermal conductive oil (129);
wherein an end of the thermal conductive oil output heat exchanging pump (257) is connected to an end of the thermal conductive oil heat storage and heat exchanging tank (258) and communicated with the thermal conductive oil (129); another end of the thermal conductive oil output heat exchanging pump (257) is connected to an end of the heat medium water heat exchanging device (260); and another end of the heat medium water heat exchanging device (260) is connected to another end of the thermal conductive oil heat storage and heat exchanging tank (258) and communicated with the thermal conductive oil (129);
wherein an end of the air conditioning circulating pump (206) is connected to the air conditioning cold and hot medium tank (261) and communicated with the cold and hot medium (233); another end of the air conditioning circulating pump (206) is connected to an end of the fan coil air conditioner (207) and/or the heating floor (208); and another end of the fan and coil air conditioner (207) and/or the heating floor (208) is connected to the air conditioning cold and hot medium tank (261) and communicated with the cold and hot medium (233).

27. The energy storage energy system according to claim 26, wherein the energy storage energy system comprises the liquid air storage tank (45), the liquid air (46), and the thermal conductive oil heat storage tank (270), and the thermal conductive oil heat exchanging device (272), and a thermal conductive oil heat exchanging pump (273), and an air conditioning cold and hot medium box (274), and the cold and hot medium (233), and a refrigerant water heat exchanging device (275), and an air conditioning throttle value (276), and the electric heating device (165), and the thermal conductive oil (129);
wherein an end of the refrigerant water heat exchanging device (275) is connected to the liquid air storage tank (45) through the air conditioning throttle value (276) and communicated with the liquid air (46); and another end of the refrigerant water heat exchanging device (275) is connected to the gas-liquid mixer (232) and communicated with the cold and hot medium (233);
wherein an end of the thermal conductive oil heat exchanging device (272) is connected to the air conditioning cold and hot medium box (274) through the thermal conductive oil heat exchanging pump (273) and communicated with the cold and hot medium (233); and another end of the thermal conductive oil heat exchanging device (272) is connected to the air conditioning cold and hot medium box (274) and communicated with the cold and hot medium (233);
wherein an end of the air conditioning circulating pump (206) is connected to the air conditioning cold and hot medium box (274) and communicated with the cold and hot medium (233); another end of the air conditioning circulating pump (206) is connected to an end of the fan coil air conditioner (207) and/or the heating floor (208); and another end of the fan coil air conditioner (207) and/or heating floor (208) is connected to the air conditioning cold and hot medium box (274) and connected to the cold and hot medium (233).

28. The energy storage energy system according to claim 27, wherein the energy storage energy system comprises a thermal conductive oil heat storage tank (326), a thermal conductive oil circulating pump (328), and a heater (329), and an air heating heat exchanging device (330), and a heater air inlet (331), and a heater air outlet (332), and a fan (333);
wherein the thermal conductive oil heat storage tank (326) is provided with an electric heating device (165), and the electric heating device (165) is immersed in the thermal conduction oil (129);
wherein the heater (329) is provided with an air heating heat exchanging device (330); an end of the air heating heat exchanging device (330) is connected with the thermal conductive oil heat storage tank (326) through the thermal conductive oil circulating pump (328) and communicated with the thermal conductive oil (129); and another end of the air heating heat exchanging device (330) is connected with the thermal conductive oil heat storage tank (326) and communicated with the thermal conductive oil (129).

29. The energy storage energy system according to any one according to claim 18, wherein the molten salt heat storage device (18) comprises a molten salt or thermal conductive oil heat storage outer tank (285), a molten salt or thermal conductive oil heat storage inner tank (286), and an outer/inner vacuum insulation gap (287), and the molten salt (141) or the thermal conductive oil (129), and the electric heating device (145);
wherein the outer/inner vacuum insulation gap (287) is formed in the gap between the molten salt or thermal conductive oil heat storage outer tank (285) and the molten salt or thermal conductive oil heat storage inner tank (286);
or
wherein the molten salt heat storage device (18) comprises the molten salt or thermal conductive oil heat storage outer tank (288), a molten salt or thermal conductive oil heat storage inner tank (289), and the outer/inner vacuum insulation gap (287), and the high temperature insulation material (290), and the molten salt (141) or the thermal conductive oil (129), and the electric heating device (145);
wherein the outer/inner vacuum insulation gap (287) is formed in the gap between the molten salt or thermal conductive oil heat storage outer tank (288) and the molten salt or thermal conductive oil heat storage inner tank (289), and the high temperature insulation material (290) is added;
or
wherein the molten salt heat storage device (18) comprises the molten salt heat storage outer tank (291), a molten salt heat storage inner tank (292), and a high temperature insulation material of the outer/inner tank (290), and a burner (293), and a flame heat radiation sheath (294), a flame (295), and a chimney (296);
wherein a gap between the molten salt heat storage outer tank (291) and the molten salt heat storage inner tank (292) is filled with the high temperature insulation material (290); the burner (287) is provided on a lower of the molten salt heat storage outer tank (291); and the flame (295) passes through the molten salt (141), and the flame (295) burns in the flame heat radiation sheath (294); and the flame heat radiation sheath (294) is provided between the flame (295) and the molten salt (141).

30. The energy storage energy system according to claim 14, wherein the molten salt heat storage comprises a solid heat storage device (297), a fire-resistant insulation brick (298), and a solid heat storage material (299);
wherein the solid heat storage material (299) is provided in the fire-resistant insulation brick (298); and the electric heating device (145) is provided in the solid heat storage material (299) and is in contact with the solid heat storage material (299).
